(19) United States
(12) Patent Application Publication
(10) Pub. No.: US 2016/0226627 A1
(43) Pub. Date: Aug. 4, 2016

(54) COMMUNICATION PROCESSING DEVICE, INTEGRATED CIRCUIT, WIRELESS COMMUNICATION TERMINAL, MEMORY CARD, WIRELESS COMMUNICATION DEVICE, AND WIRELESS COMMUNICATION METHOD

(71) Applicant: KABUSHIKI KAISHA TOSHIBA, Minato-ku (JP)

(72) Inventors: Toshihisa NABETANI, Kawasaki (JP); Ryoko MATSUO, Shinagawa (JP); Toshiyuki NAKANISHI, Yokohama (JP); Hirokazu TANAKA, Bunkyo (JP)

(73) Assignee: KABUSHIKI KAISHA TOSHIBA, Minato-ku (JP)

(21) Appl. No.: 14/914,171

(22) PCT Filed: Sep. 1, 2014
(86) PCT No.: PCT/JP2014/072955

§ 371 Date: Feb. 24, 2016

(30) Foreign Application Priority Data
Aug. 30, 2013 (JP) 2013-180454

(51) Int. Cl. H04L 1/16; H04W 4/00

(52) U.S. Cl. CPC H04L 1/16; H04W 4/005

(57) ABSTRACT

A communication processing device employing a negative-acknowledgement-based scheme to achieve at least either increased access efficiency or low power consumption. The communication processing device is mounted in a wireless communication device, and includes a communicator and a selector. The communicator receives a notification frame periodically transmitted. The selector performs selection of one scheme from among a positive-acknowledgement-based scheme according to which a response is sent in response to successful reception, and a negative-acknowledgement-based scheme according to which a response is sent in response to unsuccessful reception, the selection being performed in accordance with whether or not the communicator has received the notification frame. The communicator transmits a transmission frame including information requesting to send the response in accordance with the scheme selected by the selector.

### FIELD

Embodiments of the present invention relate to a communication processing device, an integrated circuit, a wireless communication terminal, a memory card, a wireless communication device, and a wireless communication method.

### BACKGROUND

In conventional wireless communication systems, as a transmission error, etc. may occur in a transmitted packet due to variation in the wireless transmission path or the like, there is a scheme according to which a transmitting terminal re-transmits the packet in response to feedback by a receiving terminal. This scheme is called ARQ (Automatic Repeat reQuest). In accordance with the ARQ, a NACK-based scheme is known as the feedback by the receiving terminal according to which a so-called negative acknowledgement (NACK) is returned only when an error has occurred as well as an ACK-based scheme according to which a positive acknowledgement (ACK) is returned when the packet has been successfully received without an error.

By using the NACK-based scheme, it is made possible to continuously transmit frames when the channel state is favorable, so that access efficiency is increased. In addition, since re-transmission processing of the NACK response frame is only required when a packet error occurs, necessary power consumption can be kept low as long as the channel state is favorable when compared with the ACK-based scheme according to which transmission/reception processing of the response frame is always necessary when a packet error does not occur.

However, in the case of the NACK-based scheme, the receiving terminal does not recognize the presence of the transmission packet when the communication with the wireless device as the communication counterpart is abruptly stopped due to rapid channel variation or the like and thus the transmission packet fails to reach the receiving terminal. As a result, the receiving terminal does not transmit the NACK response, and it is also appreciated that the transmitting terminal does not receive the NACK response. As a result, there is a problem that the transmitting terminal erroneously recognizes that the transmission packet has been successfully and correctly transmitted to the receiving terminal without causing an error and thus the re-transmission which ought to be performed fails to be performed. In addition, likewise, when the receiving terminal transmitted the NACK response but the NACK response fails to reach the transmitting terminal, the transmitting terminal does not receive the NACK response and the transmitting terminal erroneously recognizes that the transmission packet has been successfully and correctly transmitted.

In addition, there is also a problem that, when the receiving terminal suddenly fails to perform reception for some reason due to failure and exhaustion of its battery, etc., the transmitting terminal cannot get a NACK response, so that the transmitting terminal erroneously recognizes that the transmission packed is successfully and correctly transmitted, continuing transmission of the transmission packets.

In addition, there is a problem that the frequency of the NACK response becomes high when the channel state worsens, preventing increase in the access efficiency and leaving low power consumption unachieved.

For examples of related art, refer to Japanese Patent Nos. 4110522 and 5052549.

### SUMMARY

Embodiments of the present invention achieve at least either increased access efficiency or low power consumption.

According to one embodiment of the present invention, a communication processing device mounted in a wireless communication device, the communication processing device includes a communicator and a selector.

The communicator receives a notification frame periodically transmitted.

The selector performs selection of one scheme from among a positive-acknowledgement-based scheme according to which a response is sent in response to successful reception, and a negative-acknowledgement-based scheme according to which a response is sent in response to unsuccessful reception, the selection being performed in accordance with whether or not the communicator has received the notification frame.

The communicator transmits a transmission frame including information requesting to send the response in accordance with the scheme selected by the selector.

### BRIEF DESCRIPTION OF THE DRAWINGS

FIG. 1 is a diagram illustrating a wireless communication system in accordance with a first embodiment.

FIG. 2 is a sequence diagram illustrating an example of positive acknowledgement.

FIG. 3 is a sequence diagram illustrating an example of negative acknowledgement.

FIG. 4 is a diagram illustrating a first example of drawbacks associated with a negative-acknowledgement-based scheme.

FIG. 5 is a block diagram of a wireless communication device in accordance with a first embodiment.

FIG. 6 is a diagram illustrating an example of utilization of a wireless communication system in accordance with a second embodiment.

FIG. 7 is a block diagram of a first example of the wireless communication device in accordance with the second embodiment.

FIG. 8 is a block diagram of a second example of the wireless communication device in accordance with the second embodiment.

FIG. 9 is a diagram illustrating a second example of drawbacks associated with the negative-acknowledgement-based scheme.

FIG. 10 is a block diagram of a wireless communication device in accordance with a third embodiment.

FIG. 11 is a block diagram of a wireless communication device in accordance with a fourth embodiment.

FIG. 12 is a block diagram of a wireless communication device in accordance with a fifth embodiment.

FIG. 13 is a block diagram of a wireless communication device in accordance with a sixth embodiment.

FIG. 14 is a block diagram of a wireless communication device in accordance with a seventh embodiment.

FIG. 15 is a hardware block diagram of a wireless communication device in accordance with an eighth embodiment.

FIG. 16 is a perspective view of a wireless communication terminal in accordance with a ninth embodiment.

FIG. 17 is a diagram illustrating a memory card in accordance with the ninth embodiment.

FIG. 18 is a diagram illustrating a wireless communication system in accordance with a tenth embodiment.

FIG. 19 is a hardware block diagram of a node in accordance with the tenth embodiment.

FIG. 20 is a hardware block diagram of a hub in accordance with the tenth embodiment.

FIG. 21 is a flow chart of an example of basic operation in accordance with the first embodiment.

FIG. 22 is a flow chart of an example of basic operation in accordance with the second embodiment.

FIG. 23 is a flow chart of an example of basic operation in accordance with the third embodiment.

FIG. 24 is a flow chart of an example of basic operation in accordance with the fourth embodiment.

### DETAILED DESCRIPTION

Embodiments of the present invention are described in detail below with reference to the drawings.

### First Embodiment

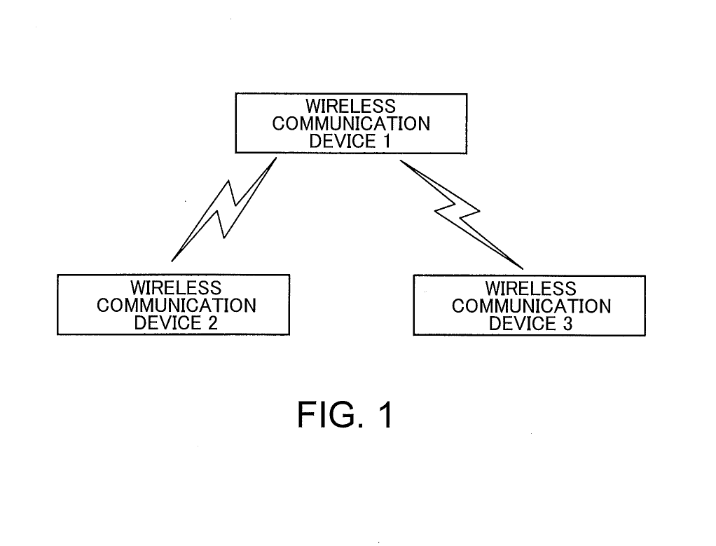

FIG. 1 is a schematic diagram that illustrates a wireless communication system in accordance with a first embodiment of the present invention.

The wireless communication system includes wireless communication devices 1 to 3. Although three wireless communication devices are illustrated in FIG. 1, the number of the wireless communication devices is not limited to the illustrated example. In this wireless communication system, for example, the wireless communication device 1 is a so-called master station and the wireless communication devices 2 and 3 are slave stations. The wireless communication device 1 which is the master station performs communications with the wireless communication devices 2 and 3 which are the slave stations. The wireless communication device 1 which is the master station periodically transmits a signal indicative of a beacon frame (“notification signal” or “beacon signal”) which is the notification frame so as to notify to the slave stations various information including wireless communication system parameters. It should be noted that the transmission of the beacon signal is to be performed by broadcast communications, but it may also be performed by multicast communications. Although FIG. 1 illustrates the example where the communications are performed between the master station and the slave station, it is also possible that the communications are performed between the slave stations in addition to the communications between the master station and the slave station.

The following description first describes a positive-acknowledgement-based scheme and a negative-acknowledgement-based scheme discussed in this embodiment as well as the outline of the operation in accordance with this embodiment, and then describes the details of the slave stations (wireless communication devices 2 and 3).

After the wireless communication device 2 transmitted a frame to the wireless communication device 1, the wireless communication device 2 determines whether or not the frame has been correctly transmitted to the wireless communication device 1 on the basis of a response from the wireless communication device 1. There are two types of response schemes, i.e., the positive-acknowledgement-based scheme and the negative-acknowledgement-based scheme.

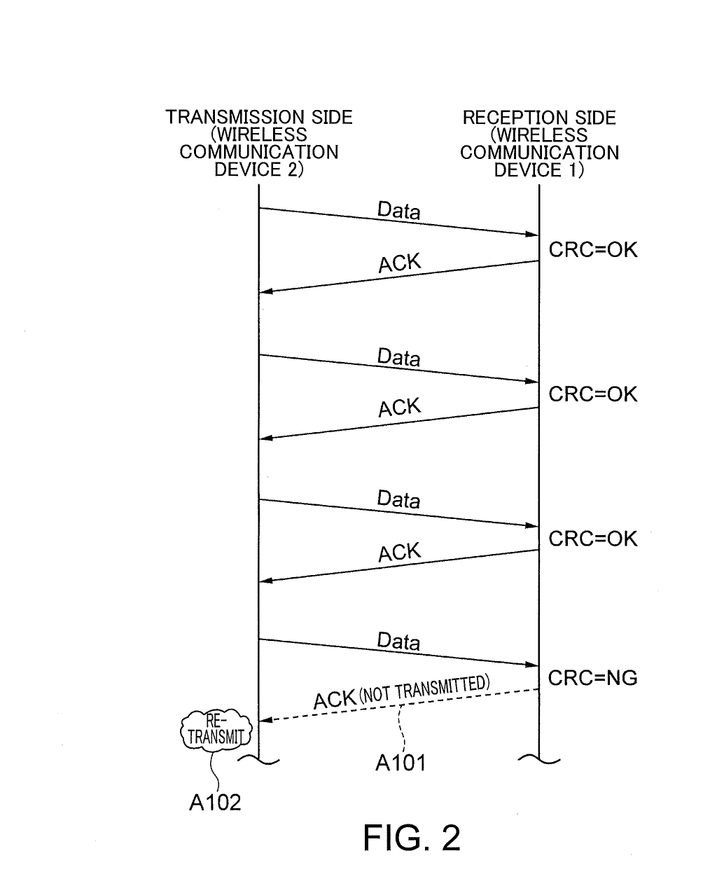

The positive-acknowledgement-based scheme refers to a scheme where a response is transmitted to the wireless communication device 2 when the wireless communication device 1 has successfully and correctly received the frame without an error. FIG. 2 is a sequence diagram that illustrates the positive-acknowledgement-based scheme. As illustrated in FIG. 2, the wireless communication device 2 transmits a data frame and the wireless communication device 1 confirms that there is not an error in the received data frame (in the illustrated example, the error detection is carried out using Cyclic Redundancy Check (CRC)) and then returns a positive acknowledgement, i.e., an ACK response. The wireless communication device 1, when having detected an error existing in the received data frame, does not return the positive acknowledgement (A101).

The wireless communication device 2, when having received the positive acknowledgement, recognizes that the wireless communication device 1 has successfully received the frame. When the positive acknowledgement is not received, then the wireless communication device 2 recognizes that the wireless communication device 1 did not succeed in correctly receiving the frame. In the latter case, the wireless communication device 2 performs re-transmission of the frame as required (A102).

The positive-acknowledgement-based scheme includes a normal ACK-based scheme where the response is provided for every transmission frame and a Block ACK (BA)-based scheme where an ACK response is provided collectively for a plurality of transmission frames. Although the following discusses the example of the normal ACK-based scheme, both schemes are available.

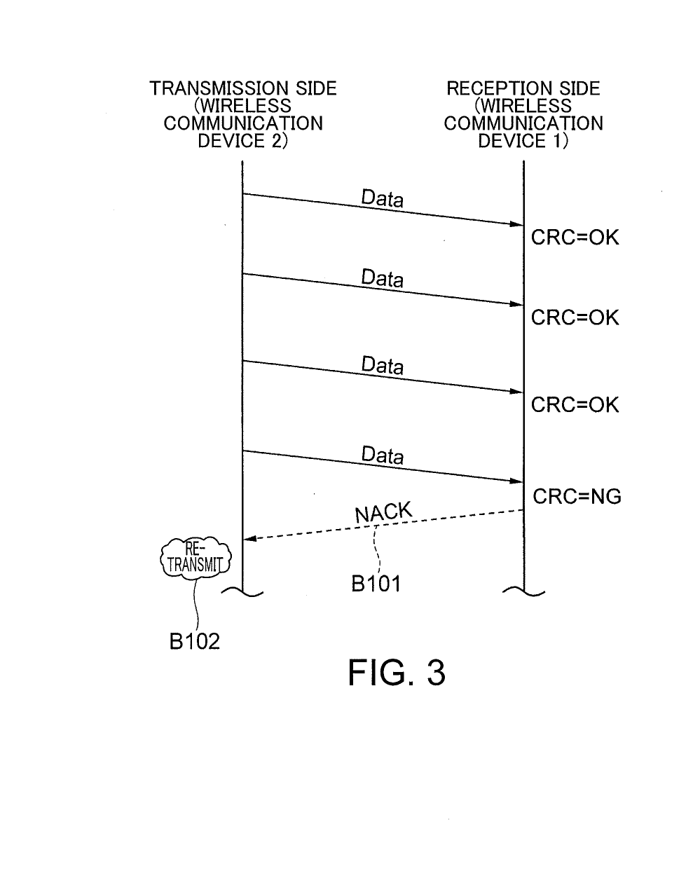

Meanwhile, the negative-acknowledgement-based scheme is a scheme in which a response is transmitted to the wireless communication device 2 when the wireless communication device 1 did not succeed in correctly receiving a frame. FIG. 3 is a sequence diagram that illustrates the negative-acknowledgement-based scheme. As illustrated in FIG. 3, the wireless communication device 1 sends no response when there is no error in the data frame that has been received from the wireless communication device 2. Meanwhile, the wireless communication device 1 sends a negative acknowledgement, i.e., a HACK response when it has been detected that there is an error in the data frame that was received from the wireless communication device 2 (B101).

The wireless communication device 2, when the negative acknowledgement was not received from the wireless communication device 1, recognizes that the wireless communication device 1 successfully received the frame. The wireless communication device 2, when the negative acknowledgement was received from the wireless communication device 1, recognizes that the wireless communication device 1 did not succeed in correctly receiving the frame. In the latter case, the wireless communication device 2 performs re-transmission of the frame as required (B102).

Since the wireless communication device 2 is allowed to continuously perform the frame transmission as long as a negative acknowledgement is not received from the wireless communication device 1, the access efficiency is high. In addition, since the wireless communication device 2 has only to perform frame reception processing when the frame was not correctly transmitted, the power consumption is low. The negative-acknowledgement-based scheme includes, in the same manner as the positive-acknowledgement-based scheme, in addition to the normal NACK-based scheme, a Block NACK response (NBA response) based scheme in which a NACK response is provided collectively for a plurality of transmission frames. Although the following discusses the example of the normal NACK-based scheme, both schemes are available.

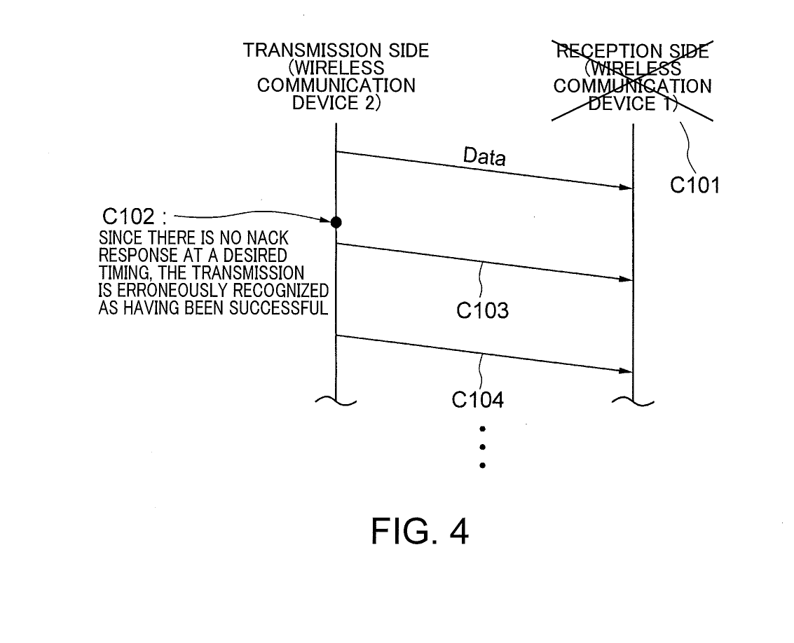

The negative-acknowledgement-based scheme, which has advantages in terms of the access efficiency and the power consumption, involves the following problems. FIG. 4 is a sequence diagram illustrating a drawback associated with the negative-acknowledgement-based scheme. There may be a case where the wireless communication device 1 suddenly fails to successfully perform the communications for a certain reason such as failure and exhaustion of its battery, etc. and a case where the wireless communication device 1 is moved and placed outside of the communication area of the wireless communication device 2. FIG. 4 indicates these cases by the reference sign C101. In such a case, there should be no response from the wireless communication device 1 in response to the frame transmission by the wireless communication device 2. The wireless communication device 2 erroneously recognizes that the transmission has been successful due to the absence of the NACK response from the wireless communication device 1 (C102), and thereafter continues to transmit the frames despite the fact that the communications with the wireless communication device 1 are not available (C103, C104).

In order to overcome problems of this kind, in accordance with this embodiment, the switching between the NACK-based scheme and the ACK-based scheme is performed relying upon presence or absence of reception of the beacon signal that is periodically transmitted from the wireless communication device 1 which is the master station. It should be noted that the beacon signal is a signal which carries the wireless communication system parameter and the like and is a notification signal that is periodically transmitted from the master station.

The wireless communication device 2 is allowed, by virtue of receiving the beacon signal that is periodically transmitted from the master station, to periodically confirm whether or not the wireless communication device 1 suddenly fails to perform communications for a certain reason such as failure and exhaustion of the battery or the like, and whether or not the wireless communication device 1 is placed out of the range of the communication area as it moves.

When the beacon signal reception has been successful at the reception timing of the periodically occurring beacon signal, the wireless communication device 2 determines that the wireless communication device 1 is correctly operating within the communication area and without failure or the like. In this case, the wireless communication device 2 selects the NACK-based scheme as the response scheme for the data frame to be transmitted to the wireless communication device 1, and includes, in that data frame, information requesting to send a response in accordance with the NACK-based scheme. After that, the NACK-based scheme is selected as the response scheme for the data frames to be transmitted to the wireless communication device 1 until the next reception timing of the beacon signal is reached. When the beacon signal reception again becomes successful at the next reception timing of the beacon signal, then the NACK-based scheme is again selected as the response scheme for the data frames to be transmitted to the wireless communication device 1, and the data frame including information requesting to send a response in accordance with the NACK-based scheme is transmitted until the next beacon signal reception timing is reached.

Meanwhile, when the beacon signal from the wireless communication device 1 was not successfully received at the reception timing of the beacon signal, the wireless communication device 2 determines that the wireless communication device 1 has moved and is now positioned out of the communication area or the wireless communication device 1 may have failed to perform communications due to a failure or the like. In this case, the wireless communication device 2 selects the ACK-based scheme as the response scheme for the data frames to be transmitted to the wireless communication device 1 and include, in that data frame, the information requesting to send a response in accordance with the ACK-based scheme.

Meanwhile, even when the wireless communication device 1 remains within the communication area and does not fail to perform communications due to a failure or the like, it may happen that the beacon signal temporarily fails to be received due to sudden change in the wireless communication channel. In view of this, the following method many be used.

Specifically, when the beacon signal was not successfully received from the wireless communication device 1 at the reception timing of the beacon signal, the response scheme is once selected as the ACK-based scheme, and then the data frame including information requesting to send a response in accordance with the ACK-based scheme is transmitted to the wireless communication device 1. Since the presence of the wireless communication device 1 can be confirmed at the time when the ACK response frame is correctly sent from wireless communication device 1, the NACK-based scheme is selected, until the next beacon signal reception timing is reached, for the subsequent transmission of the data frames to the wireless communication device 1.

By virtue of such implementation, when the wireless communication device 2 which is the slave station transmits the data frame to the wireless communication device 1 which is the master station and transmits the periodical beacon signal, switching between the NACK-based scheme and the ACK-based scheme as well as selection thereof is performed while confirming the presence of the wireless communication device 1. As a result, it is made possible to prevent continuation of unnecessary data frame transmissions due to possible erroneous recognition resulting from the NACK-based scheme as illustrated in FIG. 4 and further the effects of lower power consumption and increase in the access efficiency can be expected using the NACK-based scheme.

In this manner, in accordance with the first embodiment of the present invention, the wireless communication device 2 which is the slave station selects the NACK-based scheme or the ACK-based scheme after confirming the presence of the wireless communication device 1 using the periodical beacon signal transmitted from the wireless communication device 1 which is the master station. Meanwhile, in the case of communications between the slave stations, for example, in a case where the wireless communication device 2 transmits the data frame to the wireless communication device 3, it is not possible to confirm the presence of the wireless communication device 3 from the beacon signal transmitted from the wireless communication device 1, so that it is desirable that the wireless communication device 2 selects the ACK-based scheme and transmits the data frame including information requesting to send a response in accordance with the ACK-based scheme.

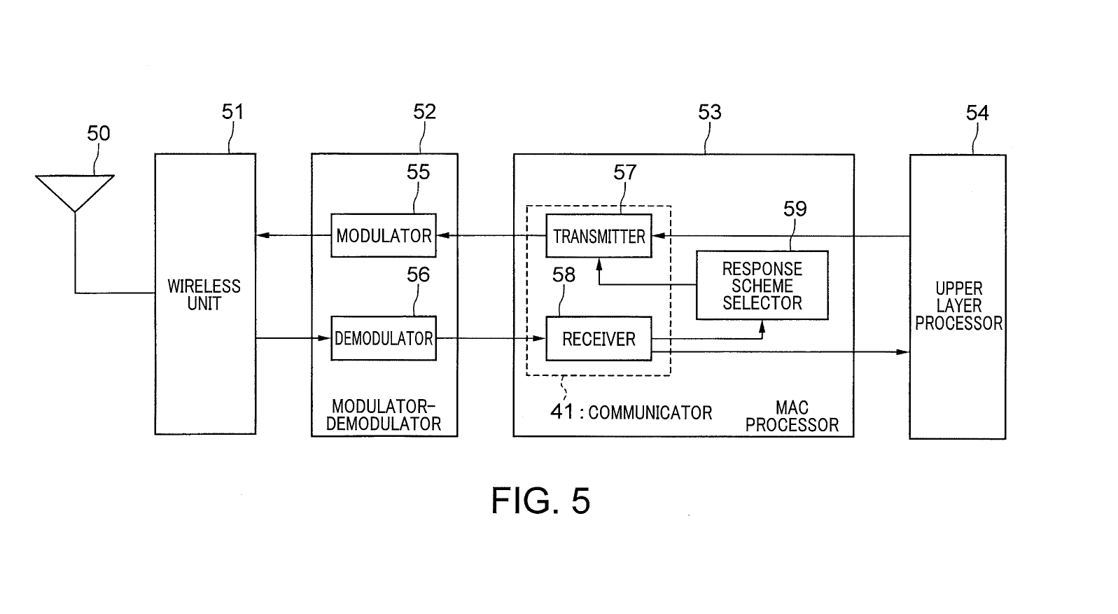

FIG. 5 is a block diagram of the wireless communication device 2. While the configuration of the wireless communication device 2 is illustrated herein, the wireless communication device 3 also has the same or similar configuration. Accordingly, explanation of the wireless communication device 3 is omitted.

The wireless communication device 2 includes an antenna 50, a wireless unit 51, a modulator-demodulator 52, a MAC processor (communication processing device) 53, and an upper layer processor 54. The modulator-demodulator 52 includes a modulator 55 and a demodulator 56. The MAC processor (communication processing device) 53 includes a communicator 41, which includes a transmitter 57 and a receiver 58, and a response scheme selector 59.

The upper layer processor 54 generates a data frame to be transmitted. The upper layer processor 54 generates, for example, a data frame including sensing information of a biological sensor, etc. The sensing information may be a sensor value as such or may be data obtained by subjecting the sensor value to processing such as normalization by a prescribed application program. The sensing information may include information indicative of the state of the sensor (such as whether the sensor is working or not). In addition, information on the sensor type and the sensing date and time may be included in the data frame along with the sensing information. A data frame may be generated that does not include the sensing information but includes any appropriate information. The upper layer processor 54 may be configured by a processor such as a CPU or may be configured by hardware, or may be configured by both software and hardware. The upper layer processor 54 may perform communication processing such as TCP/IP and UDP/IP of the layers upper than the MAC layer. In addition, it may perform the processing of the application layer for processing the sensing information.

The transmitter 57 receives the data frame generated by the upper layer processor 54 and stores it in an internal transmission buffer (not shown).

The response scheme selector 59 determines whether or not the response scheme should be set to the ACK-based scheme or the BA-based response scheme (hereinafter simply referred to as the ACK-based scheme) or the NACK-based scheme or the BNACK-based scheme (hereinafter simply referred to as the NACK-based scheme) for the next data frame to be transmitted among the data frames stored in the transmission buffer of the transmitter 57.

The response scheme selector 59 receives from the receiver 58 the notification of the presence or absence of the reception of the beacon signal that is periodically transmitted from the wireless communication device 1, and performs selection of the response scheme in accordance with this notification. When a notification has been received to the effect that the reception of the beacon signal occurred at a desired beacon signal reception timing in accordance with the period of the beacon signal, the NACK-based scheme remains to be selected until the next beacon signal reception timing is reached. When the notification to the effect that there is the reception of the beacon signal is not received, then the ACK-based scheme remains to be selected prior to the reception timing of the next beacon signal being reached. It should be noted that a predefined response scheme, for example, the ACK-based scheme may be selected when the frame transmission may take place before starting reception of the beacon signal at the start of operation or the like. The response scheme selector 59 notifies the response scheme thus determined to the transmitter 57.

The transmitter 57 performs processing such as addition of a desired MAC header for the data frame to be transmitted. This processing also includes setting a value indicative of the response scheme specified by the response scheme selector 59 in the response type notification field within the MAC header. When the response scheme notified from the response scheme selector 59 is the ACK-based scheme, then a value indicative of the ACK-based scheme is included in the frame, and a value indicative of the NACK-based scheme is included in the frame in response to notification of the NACK-based scheme. The transmitter 57 output the data frame that has been processed to the modulator 55. Specifically, the transmitter 57 transmits the data frame that has been processed as the transmission frame. It should be noted that the value indicative of the ACK-based scheme corresponds to the information requesting to send a response in accordance with the positive-acknowledgement-based scheme according to which the response is sent when the reception has been successful, and the value indicative of the NACK-based scheme corresponds to the information requesting to send a response in accordance with the negative-acknowledgement-based scheme according to which the response is sent when the reception has not been successful.

The modulator 55 is configured to perform desired processing associated with the physical layer such as modulation processing and addition of a physical header for the frame (transmission frame) input from the transmitter 57.

The wireless unit 51 is configured to perform digital-to-analog conversion and frequency conversion for the frame output from the modulator 55 and to radiate a frame signal in the form of a radio wave into the air via the antenna 50.

At the time of reception of the frame, the wireless unit 51 performs frequency conversion to baseband and analog-to-digital conversion for the signal that has been received via the antenna 50 and output the frame that has been processed to the demodulator 56.

The demodulator 56 performs desired processing associated with the physical layer such as demodulation processing and analysis of the physical header for the frame that has been input from the wireless unit 51 and outputs the frame that has been processed to the receiver 58.

The receiver 58 performs analysis of the MAC header of the frame that has been input from the demodulator 56 and the like. When the received frame is a response frame for the data frame that has been transmitted from the transmitter 57, then the receiver 58 determines that the re-transmission processing of the data frame should be performed in accordance with the content of the response. For example, when the ACK-based scheme is selected, it is determined that the re-transmission processing should be performed when the ACK response is not sent from the wireless communication device 1. Also, when the NACK-based scheme is selected, it is determined that the re-transmission should be performed when the NACK response is sent. When it has been determined that the re-transmission should be performed, the transmitter 57 re-transmits the frame.

In addition, the receiver 58 outputs the frame that has been processed to the upper layer processor 54 when the received frame is a data frame of down link for the wireless communication device 2.

In addition, when the received frame is the beacon signal frame transmitted from the master station, the receiver 58 notifies the beacon signal to the upper layer processor 54, and further notifies to the response scheme selector 59 the fact that the reception of the beacon signal exists. The period and the timing of the beacon signal transmitted from the master station are already identified on the side of the wireless communication device 2 which is the slave station.

The response scheme selector 59 uses the reception notification of the beacon signal and performs the selection of the response scheme. The response scheme selector 59, when having received the notification from the receiver 58 to the effect that the beacon signal has been successfully and correctly received in accordance with the desired timing corresponding to the period of the beacon signal, selects the NACK-based scheme for the transmission data frames to the master station until the next beacon signal reception timing is reached. Meanwhile, the response scheme selector 59 selects the ACK-based scheme as the response scheme when the notification of the beacon signal reception was not received from the receiver 58 at the desired timing.

Here, the receiver 58 may notify the fact of the reception of the ACK frame to the response scheme selector 59 when the ACK-based scheme is selected and the reception of the ACK frame for the data frame has been confirmed. In this case, the response scheme selector 59, upon reception of that notification, may switch the response scheme of the data frame transmission for the master station to the NACK-based scheme, and selects the NACK-based scheme until the next beacon signal reception timing.

It should be noted that, in this embodiment, the beacon signal reception determination is performed for every reception timing of the beacon signal and the response scheme is selected. However, the beacon signal reception determination and selection of the response scheme may be performed at a reception timing which is a predetermined period or an appropriate period. In addition, in this embodiment, the selection of the response scheme is performed for the data frame as the transmission frame. However, selection of the response scheme may be performed, as one example, for a control frame other than the transmission frame. In this case, a value indicative of the selected response scheme may be stored in the control frame.

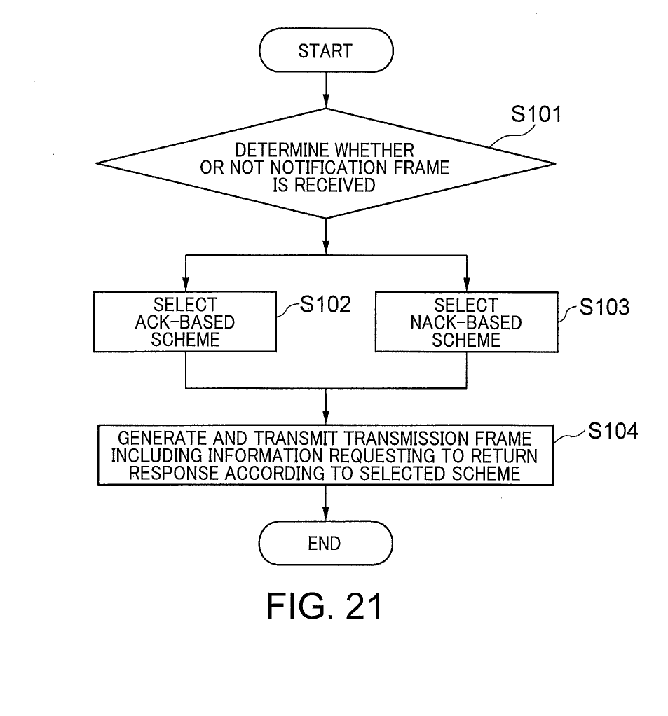

FIG. 21 is a flow chart of an example of basic operation in accordance with the first embodiment. The wireless communication devices 2 and 3 determine whether or not the notification frame, which is transmitted from the wireless communication device 1 that periodically transmits the notification frame (beacon frame), has been received (S101). When the reception is successful, then the ACK-based scheme (positive-acknowledgement-based scheme) is selected (S102). When the reception is not successful, then the NACK-based scheme (negative-acknowledgement-based scheme) is selected (S103). The wireless communication devices 2 and 3 generate a transmission frame including information requesting to send a response in accordance with the scheme selected in the step S102 or S103 and transmit the transmission frame to the wireless communication device 1 (S104).

As described above, in accordance with this embodiment, the NACK-based scheme or the ACK-based scheme is selected in response to presence or absence of the reception of the beacon signal periodically transmitted from the wireless communication device 1 which is the master station. In other words, it is made possible to select the NACK-based scheme or the ACK-based scheme while confirming the presence of the wireless communication device 1. As a result, it is made possible to prevent continuation of unnecessary data frame transmissions due to possible erroneous recognition resulting from the NACK-based scheme and further the effects of lower power consumption and increase in the access efficiency can be expected using the NACK-based scheme.

### Second Embodiment

The second embodiment is characterized in that selection of the response schemes between the NACK-based scheme and the ACK-based scheme is performed in accordance with a location of installation of the wireless communication device.

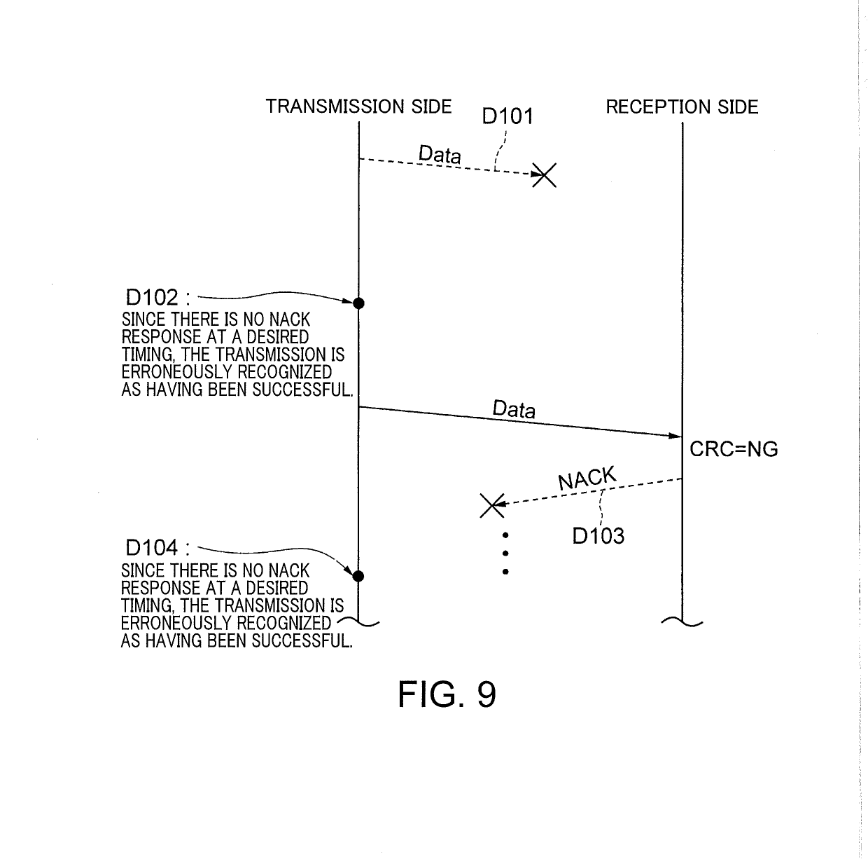

As the problems involved in the NACK-based scheme, the following problems may be mentioned: In a situation where the frame error rate is high, frequent transmission and reception of the NACK response frames occur between the wireless transmission/reception devices, as a result of which the effects of lower power consumption and increase in the access efficiency using the NACK-based scheme are undermined. In addition, in an environment where the communication channel state fluctuates due to fading or the like, cases will frequently occur where, as illustrated in FIG. 9, frames cannot be received by the other party of the transmission (D101). In this case, since there is no NACK response at a desired timing, the wireless communication device that transmitted the frame erroneously recognizes that the frame transmission was successfully and correctly transmitted (D102), causing a problem that the re-transmission processing fails to be performed despite the fact that the re-transmission is in fact necessary. In addition, this problem also occurs in a case where, even when the frame has been delivered to the counterpart device, the NACK response that has been transmitted from the counterpart device fails to reach the wireless communication device that transmitted the frame (D103, D104).

In view of this, the second embodiment focusing attention to the fact that variations in the frame error rate and the channel state differ depending upon the locations of installation of the wireless communication devices and provides selection of the response scheme in accordance with the locations of installation.

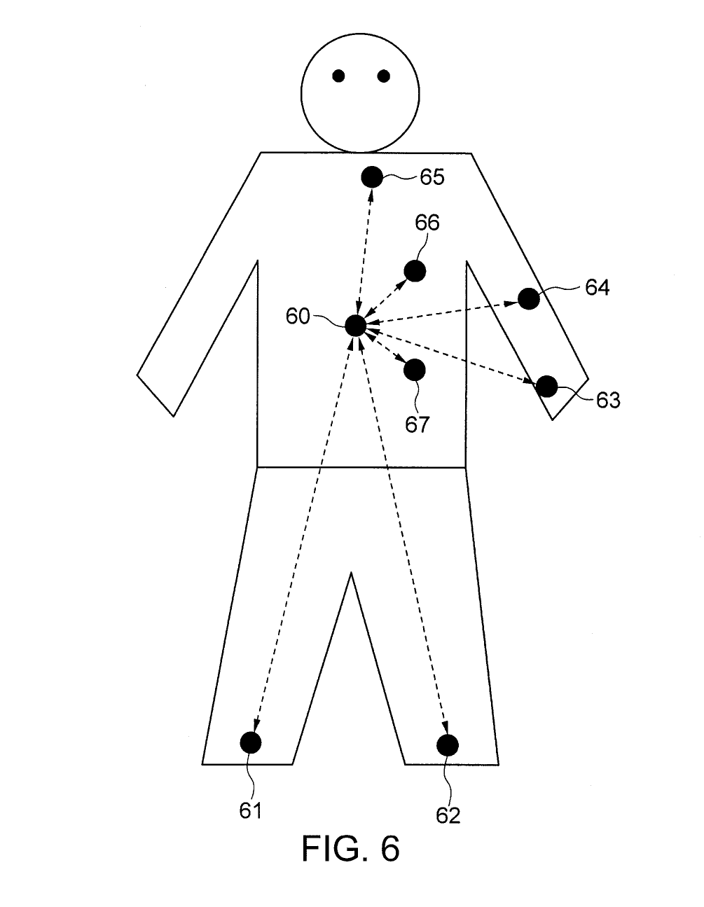

In the second embodiment, as illustrated in FIG. 6, an example is discussed in the context of a BAN (Body Area Network). In the body area network, the individual wireless communication devices are attached to a human body, and they perform communications with each other in a state where they are attached to the human body. The wireless communication device 60 or a terminal incorporating the wireless communication device 60 represents a so-called master station (hub), and the wireless communication devices 61 to 67 or terminals incorporating the wireless communication devices 61 to 67 represent the slave stations (nodes). It should be noted that the number of the slave stations is not limited to the illustrated example.

Here, although a centralized management type communication scheme is illustrated where types of stations exist such as the master station and the slave station; it is also possible that a distributed type communication scheme is also available where no master station (control station) exists. In the first embodiment, a centralized management type communication scheme is contemplated in view of the selection of the response schemes using the presence or absence of reception of the beacon signal, but this embodiment can be applied to a distributed type communication scheme, because this embodiment does not presuppose any particular operation of the master station.

In addition, in the context of this embodiment, an example is illustrated where each of the wireless communication devices is attached to a human body, but the present invention can be implemented with the wireless communication devices attached to any living body such as an animal and a plant other than the human body as long as they can be attached thereto at all. Also, in addition to the living body, it is appreciated that the wireless communication device can be installed on an object. For example, the wireless communication device may be installed on a wheel portion or underside portion of a body of an automobile.

Each of the wireless communication devices 61 to 67 which are the slave stations attached to the human body also includes a biological sensor. Each of the wireless communication devices 61 to 67 is attached to a corresponding part of the body and in this state senses the biological information from the biological sensor, and the sensed biological information is transmitted via wireless communications to the wireless communication device 60 of the master station and is thus aggregated in the wireless communication device 60. The attachment location of the body for the wireless communication devices 61 to 67 are defined in accordance with the types and the sensing usages of the biological sensors provided in the wireless communication devices 61 to 67.

Here, suppose a case where the wireless communication device 60 which is the master station is attached to the front side of the body. When the wireless communication device which is the slave station and attached to the front side in the same or similar manner as the master station is compared with the wireless communication device which is the slave station and in contrast attached to the back side of the body, then the human body becomes a shielding object in the context of the communications with the wireless communication device installed on the back side of the body, so that the wireless signal power is significantly attenuated. In view of this, it may happen that the frame error rate becomes higher in the communication between the master station and the wireless communication device installed on the back side of the body.

In addition, it can be said that the arms, legs, etc. are large portions exhibiting a large amount of motion relative to the chest, back, etc. As a result, instantaneous and rapid variation in the wireless channel state is likely to occur in the wireless communication device attached to portions exhibiting a large amount of motion such as the arms, legs, etc. under the influence of fading due to the Doppler frequency variation. In other words, the frame error rate may become higher for the wireless communication devices attached to these portions exhibiting a large amount of motion.

In this manner, in the context of the body area network, the portion (position) at which the wireless communication device is attached significantly affects the quality of the wireless communication and has significant relevance to the frame error rate.

In view of this, the response scheme selector 59 in accordance with the second embodiment performs, as the basic policy, selection of the NACK-based scheme or the ACK-based scheme depending upon the attachment position.

Specifically, in the case of the attachment position relationship in which one's own body becomes a shielding object, for example, in a case where the master station and the slave station are provided on the front side and the back side of the body, or on the right side and the left side, respectively, the wireless communication device which is the slave station selects the ACK-based scheme. This is because, in the wireless communication under such a positional relationship, the amount of attenuation is large and many frame errors are expected to occur. Meanwhile, the wireless communication device which is the slave station selects the NACK-based scheme in the case of the attachment position relationship in which devices are attached on the same side, for example, in a case where the devices are both attached on the front side of the body, one's own body does not become a shielding object. This is because the frame error is expected to be small in wireless communications under such a positional relationship.

In addition, when attached to a portion such as arms, legs, and the like, there will always be motions thereof and many frame errors are expected to occur due to the influence of fading. As a result, when a wireless communication device attached to such a portion attempts transmission or when transmission is to be performed to a wireless communication device attached to such a portion, the ACK-based scheme is selected. Meanwhile, a wireless communication device attached to a portion exhibiting a small amount of motion or when transmission is to be made to a wireless communication device attached to such a portion, the NACK-based scheme is selected. With regard to the demarcation between the portion exhibiting a large amount of motion and the portion exhibiting a small amount of motion, it may be possible that the arms, legs, etc. are defined in advance as the portions exhibiting a large amount of motion.

Alternatively, an acceleration sensor may be provided in the wireless communication device which is the slave station and the response scheme may be selected using a value of the acceleration sensor. Specifically, when the value of the acceleration sensor is equal to or larger than a certain threshold, then the portion is regarded as significantly moving and the ACK-based scheme is selected, and the data frame including information requesting to send a response in accordance with the ACK-based scheme is transmitted. Meanwhile, when the value of the acceleration sensor is smaller than the threshold, the motions of the portion are regarded as being small and thus the NACK-based scheme is selected, and the data frame including information requesting to send a response in accordance with the NACK-based scheme is transmitted. The same portion may vary in terms of its motions with the motions thereof in some cases becoming large and in other cases almost disappearing depending on the action situation, but use of the acceleration sensor makes it possible to perform switching between the NACK-based scheme and the ACK-based scheme taking such case into account.

Here, any method may be relied upon to identify the portion to which the used wireless communication device is attached. For example, when the location of attachment is defined in advance and the attachment location is known at the very outset, then the information on the location of attachment may be registered in advance in the wireless communication device. Alternatively, a designator (external interface) adapted for setting the information on the location of attachment may be provided in the wireless communication device and the user may designate the attachment location at the time of attaching the wireless communication device. Alternatively, the attachment location may be estimated from the biological information (sensing information) obtained by the biological sensor provided in the wireless communication device, and information on the estimated attachment location may be set in the wireless communication device.

In addition, although it is desirable that the selection of the response schemes is performed in accordance with the attachment location and taking into consideration both the influence of the attenuation by the human body and the influence of the fading due to motions, it is also possible that either one of them is taken into consideration so as to select the response schemes. In the context of the selection of the response scheme, it is desirable that the attachment location of the device itself and the attachment location of the communication counterpart are both taken into consideration, but either one of the attachment location of the device itself and the attachment location of the counterpart device may only be taken into consideration.

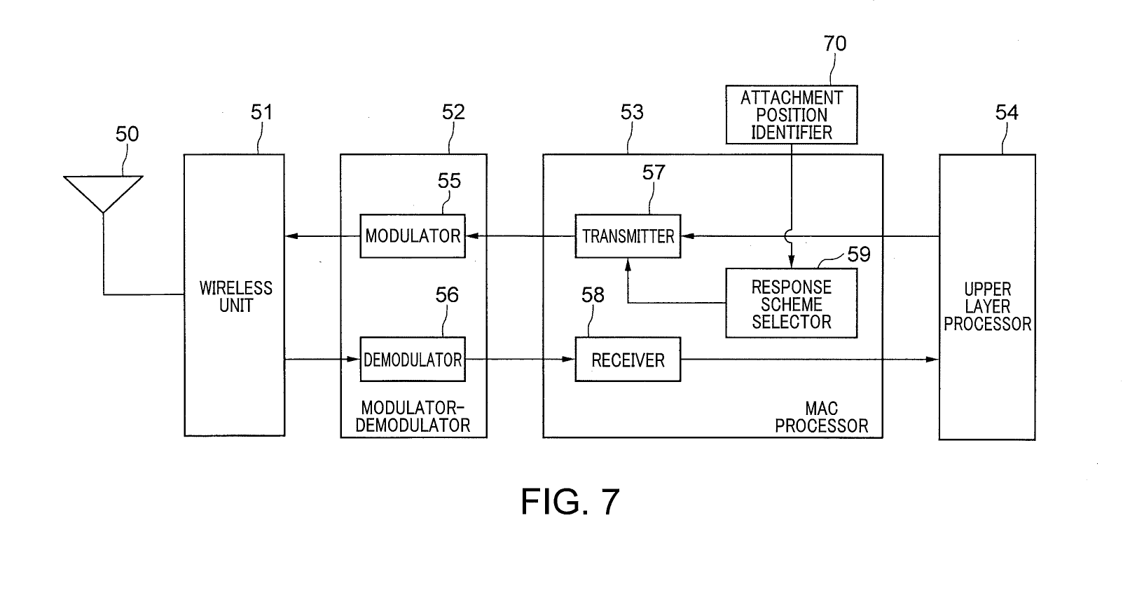

FIG. 7 is a block diagram of a first example of the wireless communication device in accordance with the second embodiment. The same reference numerals are assigned to the blocks having the same names as those of the wireless communication device in accordance with the first embodiment illustrated in FIG. 5, and redundant explanations are omitted unless the processing is expanded or modified.

In the second embodiment, an attachment position identifier 70 is added to the first embodiment. The response scheme selector 59 is configured to perform selection of the NACK-based scheme or the ACK-based scheme in accordance with the attachment location identified by the attachment position identifier 70. It should be noted that the selection of the response scheme in accordance with whether or not the beacon signal reception is successful is not performed in this embodiment, so that the receiver 58 and the response scheme selector 59 are not connected to each other. However, it is possible that this embodiment is combined with the first embodiment in which the selection of the response schemes is performed in accordance with whether or not the beacon signal reception is successful.

The attachment position identifier 70 is configured to identify the attachment location of the wireless communication device in accordance with a prescribed method.

For example, when the location of attachment is defined in advance, the information on the attachment location may be registered at the outset in the attachment position identifier 70 and the attachment position identifier 70 may notify the information to the response scheme selector 59.

When a method is used according to which the attachment location is designated at the time of attachment, the user may input the information on the attachment location via an external interface (not shown) and the attachment position identifier 70 may identify the attachment location on the basis of the information input from the external interface.

When a method is used that estimates the attachment location from the sensing information and the sensor type of the biological sensor, the attachment location may be identified by the sensing information and the sensor type of the biological sensor. For example, when the biological sensor is a temperature sensor, the attachment location may be identified from the temperature value of the sensor. In addition, the wireless communication device may include a plurality of biological sensors of different types, for example, a temperature sensor and a blood pressure sensor, and may estimate the attachment location in an integrated manner from the sensing information and the sensor types of the individual sensors. In addition, a plurality of wireless communication devices may each include a temperature sensor, and may estimate the attachment location of each of the wireless communication devices by comparing the values of the individual temperature sensors. In addition, the types of the sensors may be obtained via a user input or the types of the sensors may be notified by communications with the upper layer processor.

The response scheme selector 59 selects the response scheme on the basis of either one or both of the attachment location of the device itself and the attachment location of the counterpart device. Identification of the attachment location of the communication counterpart may be performed by obtaining via the receiver 58 a frame including information on the attachment location of the communication-counterpart wireless communication device and thus on the basis of the obtained information.

The response scheme selector 59 may create or include in advance a table including the attachment location of the device itself and the attachment location of the counterpart device and the response scheme, and the response scheme selector 59 may select the response scheme on the basis of this table. Alternatively, a table of the attachment location of the device itself and the response scheme, or a table of the attachment location of the counterpart device and the response scheme may be used to select the response scheme. Further, a function may be created whose inputs are the values indicative of the attachment location of the device itself and the attachment location of the counterpart device and whose output is a particular value identifying the response scheme, and thus the response scheme may be selected using this function.

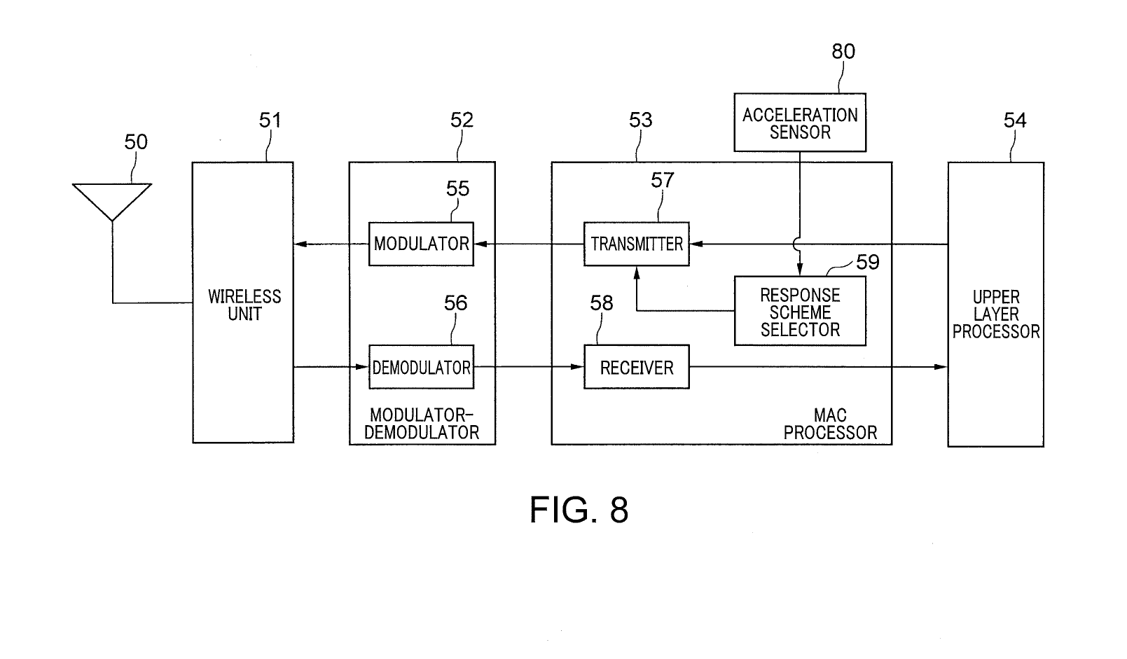

FIG. 8 is a block diagram of a second example of the wireless communication device in accordance with the second embodiment. In place of the attachment position identifier illustrated in FIG. 7, there is provided an acceleration sensor. The acceleration sensor 80 is configured to notify the sensed value of acceleration to the response scheme selector 59. The response scheme selector 59 performs selection of the response scheme in response to the notified value of acceleration. For example, the ACK-based scheme is selected when the acceleration is equal to or larger than a threshold and the NACK-based scheme is selected when the acceleration is lower than the threshold. Alternatively, switching may be made to the ACK-based scheme in response to the acceleration equal to or larger than the threshold continuing for a predetermined period of time, or switching may be made to the NACK-based scheme in response to the acceleration lower than the threshold continuing for a predetermined period of time.

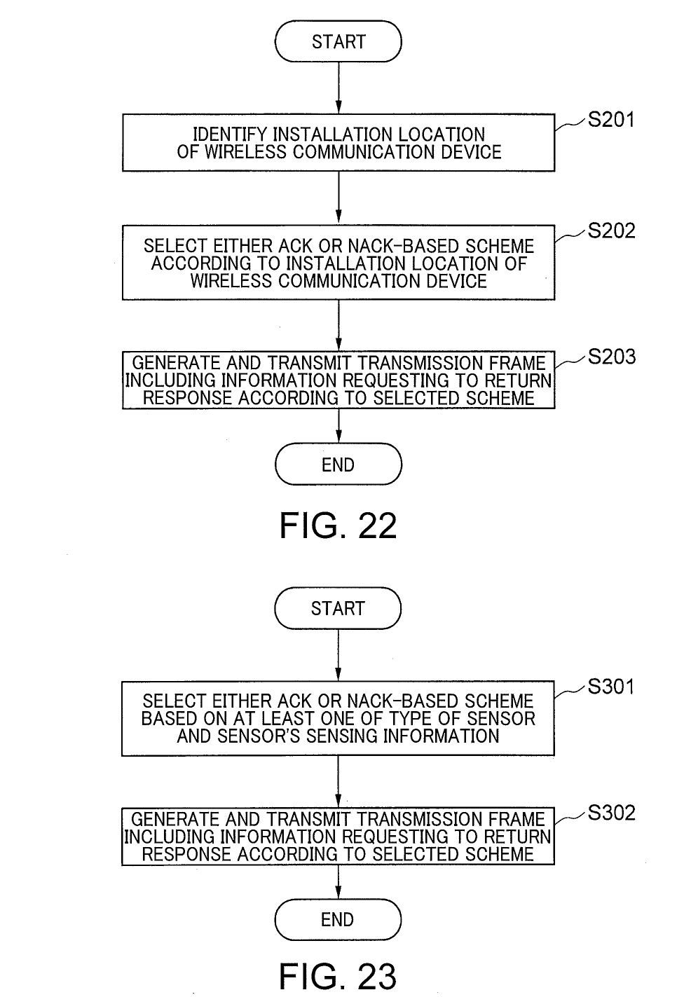

FIG. 22 is a flow chart of an example of basic operation in accordance with the second embodiment. The wireless communication devices 61 to 67 identify the locations of installation of the wireless communication devices 61 to 67 (S201) and select either one of the ACK-based scheme (acknowledgement scheme) or the NACK-based scheme (negative-acknowledgement-based scheme) in accordance with the identified locations of installation (S202). The wireless communication devices 61 to 67 transmit, to the wireless communication device 60, the transmission frame including information requesting to send a response in accordance with the scheme selected in the step S202 (S203).

As described above, in accordance with this embodiment, the ACK-based scheme is selected in a wireless communication device installed at a position where frame errors are likely to occur, and in contrast the NACK-based scheme is selected in a wireless communication device installed at a position where frame errors are less likely to occur. By virtue of this, the selection of the NACK-based scheme is only performed at the positions of installation where it is expected that the effect of the NACK-based scheme can be obtained, so that it is made possible to avoid the problems of occurrence of failure to perform re-transmission due to erroneous recognition in the NACK-based scheme and occurrence of continuation of unnecessary transmission.

### Third Embodiment

A third embodiment is characterized in that the wireless communication device includes at least one sensor, and the response scheme to be applied in wireless transmission of its sensing information is selected in accordance with at least one of the types and usages of individual sensors, the sensing information, and the sensing date and time, or in accordance with the combination thereof.

In the context of the third embodiment, an example of a biological sensor as the sensor is mentioned, but the sensor is not limited to the biological sensor and any sensor may be applicable. Here, as the biological sensor, sensors may be contemplated that are adapted to sense body temperature, blood pressure, pulse, electrocardiogram, heartbeat, blood oxygen level, urinal sugar, blood sugar, etc.

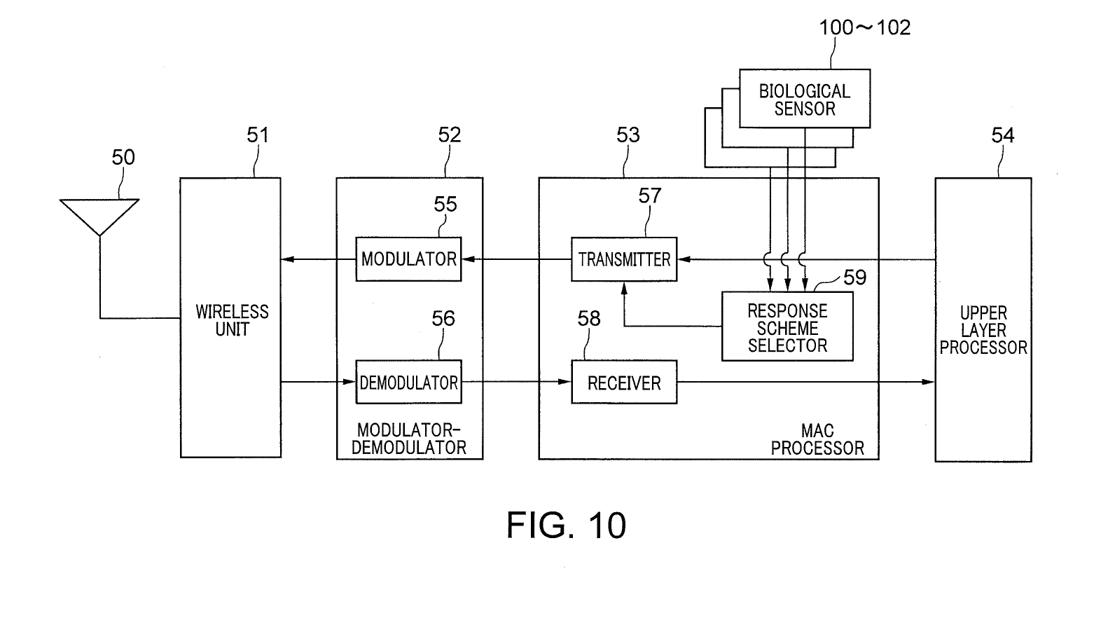

FIG. 10 is a block diagram of a wireless communication device in accordance with the third embodiment. The same reference numerals are assigned to the blocks having the same names as those of the wireless communication device in accordance with the second embodiment illustrated in FIG. 7, and redundant explanations are omitted unless the processing is expanded or modified.

As illustrated in FIG. 10, the wireless communication device according to this embodiment includes biological sensors 100 to 102. The biological sensors are sensors each configured to sense different biological information including, for example, blood pressure and electrocardiogram. It should be noted that FIG. 10 depicts three types of biological sensors but the number of the sensor is not limited to this illustrated example. The number of the sensors may be one, two, or four or more. In the context of the sensing, for example, sensing may be performed at a predetermined frequency such as a predetermined time interval and thus the sensing information may be output, or the sensing information may only be output when a particular event has been detected. Methodology of sensing may be split into multiple sensing methods in accordance with the types of the sensors.

The response scheme selector 59 is configured to perform selection of the response scheme on the basis of at least one of the types of the sensors, usages of the sensors, the sensing information, and the sensing date and time, or on the basis of the combination thereof.

[Selection in Accordance with Types of Sensors]

The response scheme selector 59 performs selection of the response scheme in accordance with the types of the sensors. The importance of the sensing information varies depending on the types of the sensors. Accordingly, when information of a sensor that senses biological information having a high importance is to be transmitted, the ACK-based scheme is selected in view of the importance of certainty. By virtue of this, failure of re-transmission due to erroneous recognition by the NACK-based scheme is prevented. In this case, the response scheme selector 59 notifies the ACK-based scheme to the transmitter 57. Meanwhile, when information of a sensor that senses biological information having a less importance is to be transmitted, the NACK-based scheme is selected. By virtue of this, low power consumption and access efficiency are preferentially ensured. In this case, the response scheme selector 59 notifies the NACK-based scheme to the transmitter 57.

[Selection in Accordance with Types and Usages of Sensors]

It may be contemplated that the degrees of importance of the sensing information may vary according to the usages even when the sensing information is sensed by the sensors of the same type. For example, it may be contemplated that even the sensing information of the same sensor may be information having an important meaning depending on the usages, and may be information having less important meaning in view of the other usages. For example, even the same temperature sensors may have different degrees of importance depending on the attachment positions. In this case, the degree of importance of each sensor is determined in advance in accordance with the usages of the sensors, and whether the importance is high (i.e., the ACK response is necessary) or not so high (i.e., there will be no problem with the NACK response) is determined in advance. Whether or not the importance is high may be registered by the user via an external interface, or the user may specify the usages and the types of the sensors and the degrees of importance may be determined in view of the usages and the types of the sensors within the wireless communication device. For example, a table of the types and usages of the sensors and the levels of the importance is retained, and the degrees of importance may be determined using this table.

Here, as the criterion for the determination of the degrees of importance, the determination is to be performed in view of the significance or impact, in terms of its usage, of the event of the failure to re-transmit the data to be transmitted and loss of that data. In any case, the baseline that should be adhered to is that the selection of the NACK-based scheme or the ACK-based scheme is performed in accordance with the types of the sensors.

[Selection in Accordance with the Sensing Information]

The response scheme selector 59 is configured to perform selection of the response schemes in accordance with the sensing information obtained by each of the biological sensors 100 to 102.

First, a case is illustrated where the selection of the response schemes is performed on the basis of the sensing information. In this case, whether the sensing target corresponds to the “normal” state or “abnormal” (or “important” or “emergency”) state is determined on the basis of the obtained sensing information. When it corresponds to the “normal” state, then the NACK-based scheme is selected in view of the low power consumption and access efficiency, and the NACK-based scheme is notified to the transmitter 57. The transmitter 57 transmits a frame including the information requesting to send a response in accordance with the NACK-based scheme and the obtained sensing information. It should be noted that the frame to be transmitted may include, in addition to the sensing information, information of at least one of the type of the sensor and the sensing date and time. Meanwhile, when it corresponds to the “abnormal” state, the ACK-based scheme is selected in view of the importance of certainty, and the ACK-based scheme is notified to the transmitter 57. The transmitter 57 transmits a frame including the information requesting to send a response in accordance with the ACK-based scheme and the obtained sensing information, etc. The specific example is illustrated below.

As one example, suppose that the biological sensor is a pulse sensor. When a value obtained by the pulse sensor falls within a certain predetermined range, it is understood that the human body, which is the sensing target, is in the normal and stable state. As a result, its urgency and importance are low as the sensing information (biological information), and the NACK-based scheme is selected with precedence given to power consumption and access efficiency.

Meanwhile, when the value obtained by the pulse sensor is beyond or below a certain predetermined range, it is understood that the human body, which is the sensing target, is in a state that is not normal, i.e., the human body is in a certain abnormal state or an emergency state. As a result, in a case of such an unstable other-than-normal state, the importance as the biological information is high, and the biological information is thought to be the one that should be reliably transmitted. Accordingly, in this case, the ACK-based scheme is selected with precedence given to reliability.

With regard to the determination of whether the value of the biological sensor corresponds to the “normal” state or the “abnormal” (or “important” or “emergency”) state, it may be examined whether or not the value that has been obtained in the above described manner falls within a predetermined range, in other words, whether the value is equal to or larger than a certain threshold or lower than another threshold. As another method, it is also possible that the determination is made on the basis of whether a relative value with respect to the previous sensing time is larger than a threshold or lower than another threshold (i.e., whether or not a rapid change has occurred). This policy can be contemplated in the same or similar manner for other biological sensors. As the thresholds, different values may be used depending on the time.

Here, as the relative value with respect to the previous sensing time, it may be contemplated, by way of example, to use a difference or ratio of the value obtained in the previous round of sensing with respect to the value obtained in the current round of sensing. Alternatively, the target whose relative value is to be obtained (for example, the target for which the difference or ratio is calculated) may be not only the value of the previous round of sensing but also the values of the X rounds prior to the current round of the sensing (where X is an integer equal to or larger than two), or may be an average of the values of first round to X-rounds-previous rounds of sensing.

Also, as an alternative method, an abnormality detection model may be provided based on learning such that the model uses the value of the biological sensor as its input and outputs a probability of occurrence of abnormality or a probability of occurrence of a sign of abnormality, and thus it may be determined that the “abnormal” state is entered when the probability of occurrence of the abnormality or the sign of abnormality that is output by the abnormality detection model becomes equal to or larger than a predetermined value. Such a model may be created by an existing method and using a large amount of time-series data including the values of the biological sensor and the presence or absence of abnormality of the human body.

In addition, instead of the selection of the response scheme for each sensor on the basis of the sensing information of the same sensor, the response scheme for each sensor or for a group of sensors may be selected by combining a plurality of sensors. For example, when the values of the plurality of sensors are each equal to or larger than the corresponding one of their certain thresholds, it may be determined that the living body is in an other-than-normal state, so that the sensing information of each sensor may be transmitted in accordance with the ACK-based scheme. In addition, when a value of a certain sensor is equal to or larger than a certain value, it may be determined that a different sensor is in an other-than-normal state, so that the sensing information of the different sensor may be transmitted in accordance with the ACK-based scheme. At this point, the sensing information of the above certain sensor may be transmitted in accordance with the NACK-based scheme, or a configuration is possible according to which the sensing information of the above certain sensor is not transmitted at all (i.e., a configuration where it is only for use in the state determination for another sensor).

[Selection in Accordance with the Sensing Date and Time]

Next, a case is illustrated where the selection of the response schemes is performed on the basis of the sensing time such as a sensing date and time. Given a certain sensor of one type, even when the sensing information of that sensor exhibits the same value, the degree of importance thereof may differ depending on the date and time of acquisition. For example, in the case of a blood sugar sensor, when comparing the value of blood sugar after eating with the value of the blood sensor in a normal state, the blood sugar value after eating has a particular significance. In addition, in some cases the sensing information during sleep is of particular importance. Meanwhile, with regard to the sensing information during sleep, the sensing information thereof may be less important. In this manner, even in the case of the same value of the sensing information of the same sensor, the degrees of importance differ depending on the dates and times of acquisition, so that whether or not the sensing information is important is determined in accordance with the date and time of acquisition. When it is important, data transmission is performed in accordance with the ACK-based scheme in view of the importance of certainty. When it is less important, then the data transmission is performed in accordance with the NACK-based scheme with precedence given to the power consumption and access efficiency.

FIG. 23 is a flow chart of an example of basic operation in accordance with the third embodiment. The wireless communication device selects either the one scheme from the ACK-based scheme (acknowledgement scheme) and the NACK-based scheme (negative-acknowledgement-based scheme) on the basis of at least one of the sensor type and the sensing information of the sensor incorporated in the wireless communication device or the sensor incorporated in a terminal including the wireless communication device (S301). The wireless communication device transmits a transmission frame to the wireless communication device which is the target of communication, the transmission frame including information requesting to send a response in accordance with the scheme selected in the step S301 and the sensing information (S302).

As described above, in accordance with this embodiment, the ACK-based scheme or the NACK-based scheme can be selected in accordance with the sensor type, the usage of the sensor, the sensing information, and the sensing date and time, which makes it possible to more adaptively select the response schemes. As a result, the problem of the failure to perform re-transmission processing due to possible erroneous recognition resulting from the NACK-based scheme and the problem of continued unnecessary communication can be prevented, and low power consumption and increase in the access efficiency can be ensured.

### Fourth Embodiment

A fourth embodiment is characterized in that the response schemes are selected in accordance with a state of charge of a battery provided in the wireless communication device or in accordance with whether or not the battery is being charged.

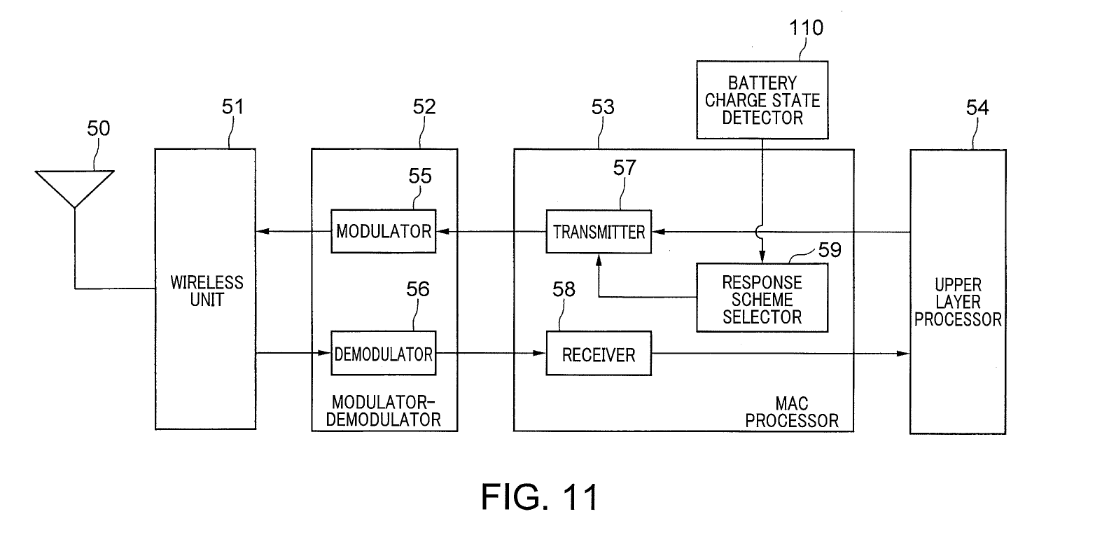

FIG. 11 is a block diagram of a wireless communication device in accordance with the fourth embodiment. A battery charge state detector 110 is further included in the configuration of FIG. 11. The same reference numerals are assigned to the elements having the same names as those in the other embodiments, and redundant explanations are omitted unless the processing is expanded or modified.

The battery charge state detector 110 is configured to detect the state of charge of the battery provided in the wireless communication device. The battery supplies electrical power as the driving source to the processor of the wireless communication device. The processor includes, for example, all or at least part of a MAC processor (transmitter, receiver, and response scheme selector), a modulator-demodulator, a wireless unit, an upper layer processor, and the battery charge state detector. The battery may be capable of being charged in a state where the wireless communication device is attached to a human body or the like. Charging may be carried out by non-contact wireless power transmission, or may be carried out by connection to an external power source via a wired power source cable. As the state of charge of the battery, by way of example, the remaining battery that is the amount of energy remaining in the battery, or the proportion of the charged capacity to the full capacity of the battery (charge level) may be mentioned. Alternatively, the battery charge state detector 110 may detect whether or not the battery is being charged.

The response scheme selector 59 selects the ACK-based scheme in view of the importance of certainty when the battery state of charge (battery's remaining capacity, charge level, etc.) detected by the battery charge state detector 110 is equal to or larger than a threshold, and notifies the ACK-based scheme to the transmitter 57. The transmitter 57 performs transmission of a data frame including information requesting to send a response in accordance with the ACK-based scheme.

The response scheme selector 59 performs switching to the NACK-based scheme taking into account the power consumption when battery state of charge becomes lower than the threshold, and notifies the switching to the transmitter 57. The transmitter 57 performs transmission of a data frame including information requesting to send a response in accordance with the NACK-based scheme. When the battery's state of charge becomes again equal to or larger than the threshold as a result of charging of the battery or the like, then switching is made again to the data frame transmission in accordance with the ACK-based scheme. However, a configuration may be possible that selects the ACK-based scheme while the battery is being charged even when the battery's state of charge becomes lower than the threshold.

As described above, in accordance with this embodiment, the ACK-based scheme is selected in view of the importance of certainty when the battery's state of charge is high (there is sufficient battery capacity remaining). By virtue of this, the problem of the failure to perform re-transmission processing due to possible erroneous recognition resulting from the NACK-based scheme and the problem of continued unnecessary communication as well as the like problems are prevented. In addition, when the battery's state of charge is low (there is not sufficient battery capacity remaining), the schemes are switched to the NACK-based scheme which allows for further power consumption taking into account the life of the battery, making it possible to extend the life of the wireless communication device.

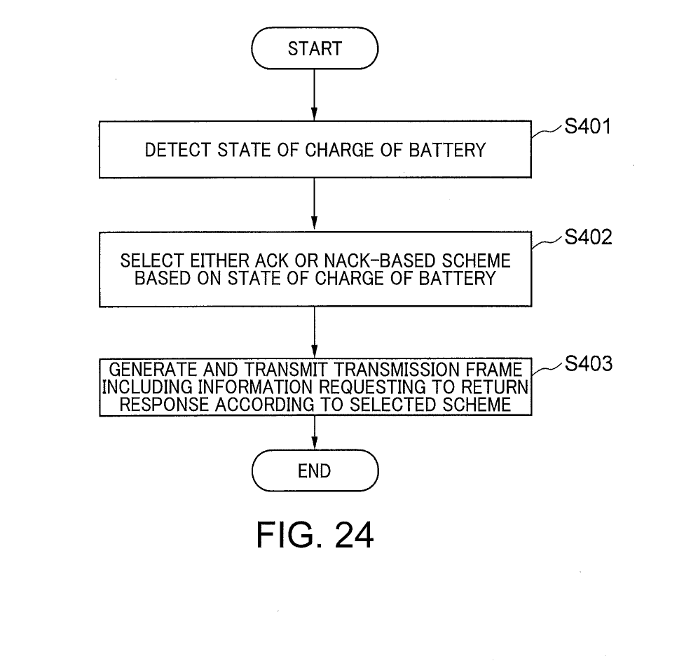

FIG. 24 is a flow chart of an example of basic operation in accordance with the fourth embodiment. The wireless communication device detects the state of charge of the battery incorporated in this wireless communication device or a battery incorporated in a terminal that includes this wireless communication device (S401). The wireless communication device then selects either one of the ACK-based scheme (acknowledgement scheme) or the NACK-based scheme (negative-acknowledgement-based scheme) on the basis of the state of charge of the battery (S402). The wireless communication device then transmits the transmission frame including information requesting to send a response in accordance with the scheme that has been selected in the step S402 to the wireless communication device which is the target of communications (S403).

### Fifth Embodiment

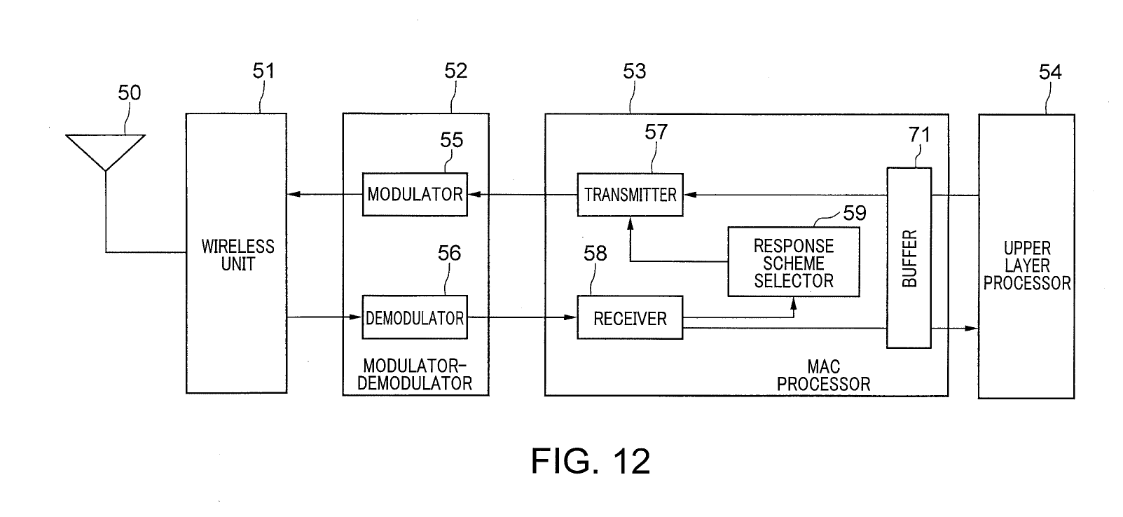

FIG. 12 is a block diagram of a wireless communication device in accordance with a fifth embodiment.

The wireless communication device illustrated in FIG. 12 has a configuration in which a buffer 71 is added to the MAC processor 53 of the wireless communication device in accordance with the first embodiment illustrated in FIG. 5. The buffer 71 is connected to the transmitter 57 and the receiver 58. The upper layer processor 54 performs input and output to/from the transmitter 57 and the receiver 58 via the buffer 71. The buffer 71 is configured, for example, by appropriate volatile memory or non-volatile memory. In this manner, since the buffer 71 is provided, the transmission data and the reception data are retained in the buffer 71 and thereby re-transmission processing or output processing for output to the upper layer processor 54 can be readily performed. Here, the example is illustrated in which the buffer is added to the wireless communication device illustrated in FIG. 5, but the buffer may be added in the same or similar manner to the wireless communication device in accordance with the other embodiments that are illustrated in FIGS. 7, 8, 10, and 11.

### Sixth Embodiment

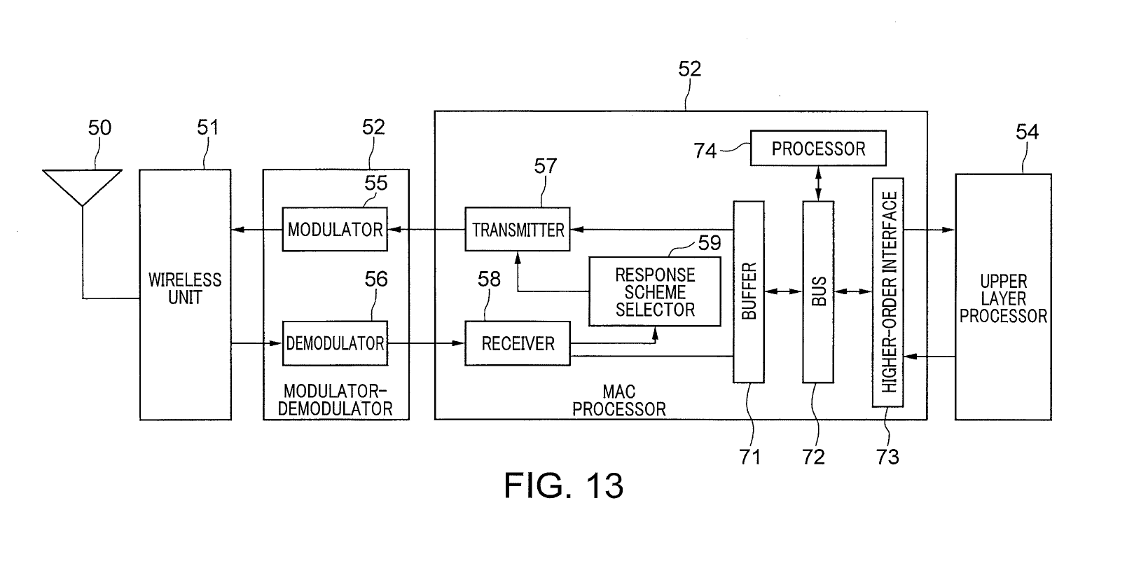

FIG. 13 is a block diagram of a wireless communication device in accordance with a sixth embodiment.

The wireless communication device illustrated in FIG. 13 has a configuration in which a bus 72 is connected to the buffer 71 in the fifth embodiment illustrated in FIG. 12, and a higher-order interface 73 and a processor 74 are connected to the bus 72. The MAC processor 52 is connected at the higher-order interface 73 to the upper layer processor 54. Firmware runs on the processor 74. By rewriting of the firmware, modifications to the functionality of the wireless communication device can be readily performed. The functionality of the response scheme selector 59 may be effectuated by the processor 74.

### Seventh Embodiment

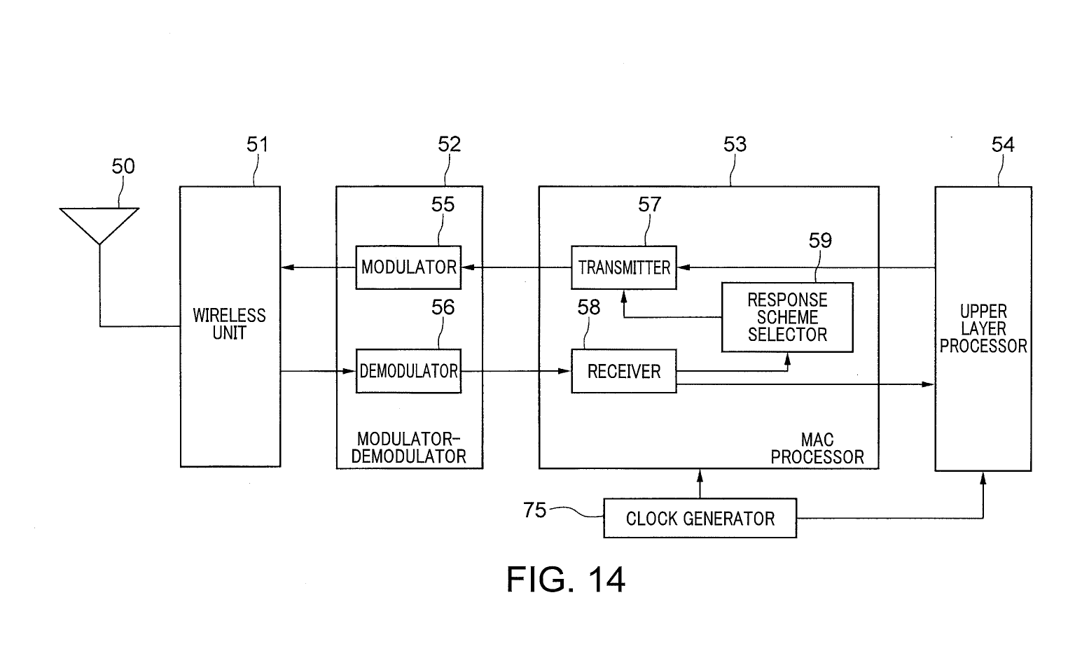

FIG. 14 is a block diagram of a wireless communication device in accordance with a seventh embodiment.

The wireless communication device illustrated in FIG. 14 has a configuration in which a clock generator 75 is connected to the MAC processor 53 in the wireless communication device in accordance with the first embodiment illustrated in FIG. 5. The clock generator 75 is connected via an output terminal to an external host (which corresponds to the upper layer processor 54), and the clock generated by the clock generator 75 is delivered to the MAC processor 53 and further output to the external host. By causing the host side to operate in accordance with the clock input in the host, it is made possible to cause the host side and the wireless communication device side to operate in synchronization with each other. In this example, the clock generator 75 is arranged outside of the MAC processor, but it may be provided inside of the MAC processor.

### Eighth Embodiment

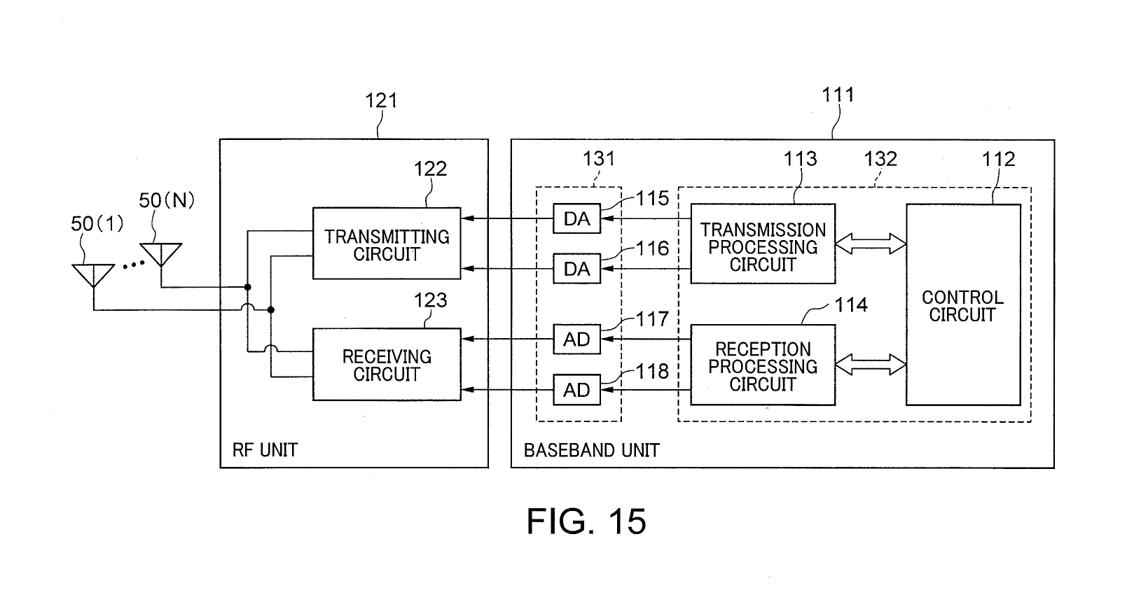

FIG. 15 illustrates an example of a hardware configuration of a wireless communication device in accordance with an eighth embodiment. This hardware configuration is only provided by way of example, and various modifications can be made to this hardware configuration. The operation of the wireless communication device illustrated in FIG. 15, detailed description of which is omitted, proceeds in the same or similar manner as in the wireless communication devices described in the context of the previous embodiments, and the following explanation focuses on the differences in respect of the hardware configuration. It should be noted that the illustrated hardware configuration can be applied both to the wireless communication device that operates as a base station and to the wireless communication device that operates as a slave station.

This wireless communication device includes a baseband unit 111, an RF unit 121, and antennas 50(1) to 50(N) (where N is an integer equal or larger than one).

The baseband unit 111 includes a control circuit 112, a transmission processing circuit 113, a reception processing circuit 114, DA conversion circuits 115, 116, and AD conversion circuits 117, 118. The RF unit 121 and the baseband unit 111 may be collectively configured as one-chip IC (integrated circuit) or may be configured as independent chips.

As one example, the baseband unit 111 is a baseband LSI or a baseband IC. Alternatively, the baseband unit 111 may include an IC 132 and an IC 131 in the illustrated manner as indicated by dotted lines. In this context, components may be incorporated in a distributed manner on these ICs such that the IC 132 includes the control circuit 112, the transmission processing circuit 113, and the reception processing circuit 114 while the IC 131 includes the DA conversion circuits 115, 116 and the AD conversion circuits 117, 118.

The control circuit 112 is mainly configured to execute the functionality of the MAC processor 53 of FIG. 5, etc. The functionality of the upper layer processor 54 may be included in the control circuit 112.

The transmission processing circuit 113 corresponds to the section that performs the processing of the modulator 55 in FIG. 5, etc. Specifically, the transmission processing circuit 113 mainly performs processing associated with the physical layer including addition of a preamble and a PHY header, encoding, modulation (which may include MIMO modulation), and generates, for example, two types of digital baseband signals (hereinafter referred to as the digital I-signal and Q-signal). It should be noted that another configuration can be contemplated according to which the functionality of the transmitter 57 of FIG. 5, etc. may be included in the transmission processing circuit 113, the functionality of the receiver 58 may be included in the reception processing circuit 114, and the functionality of the response scheme selector 59 and the function of controlling the entire MAC processor 53 may be included in the control circuit 112.

The communication processing device of this embodiment corresponds, for example, to the control circuit 112, the transmission processing circuit 113, and the reception processing circuit 114. The communication processing device of this embodiment may take either configuration of a one-chip IC configuration or a multiple-chip IC configuration.

The DA conversion circuits 115 and 116 correspond to the section associated with the digital-to-analog conversion of the wireless unit 51 of FIG. 5, etc. The DA conversion circuits 115 and 116 are configured to perform digital-to-analog conversion for the signals input from the transmission processing circuit 113. More specifically, the DA conversion circuit 115 converts a digital I-signal into an analog I-signal, and the DA conversion circuit 116 converts a digital Q-signal into an analog Q-signal. It should be noted that there may be a case where the signals are transmitted as single-channel signals without the quadrature modulation being performed. In this case, it suffices that one single DA conversion circuit is provided. In addition, when transmission signals of one single channel or multiple channels are transmitted in a distributed manner in accordance with the number of antennas, DA conversion circuits may be provided in the number corresponding to the number of the antennas.

The RF unit 121, by way of example, is an RF analog IC or a high-frequency wave IC. The transmitting circuit 122 in the RF unit 121 corresponds to the section associated with the processing at the time of transmission following the digital-to-analog conversion out of the functions of the wireless unit 51 illustrated in FIG. 5, etc. The transmitting circuit 122 includes a transmission filter that extracts a signal of a desired bandwidth from the signal of the frame that has been subjected to the digital-to-analog conversion by the DA conversion circuits 115 and 116, a mixer that performs up-conversion for the signal that has been subjected to the filtering to the wireless frequency using a signal having a predetermined frequency supplied from an oscillation device, a pre-amplifier (PA) that performs amplification for the signal that has been subjected to the up-conversion, and the like.

The receiving circuit 123 in the RF unit 121 corresponds to the section associated with the processing at the time of reception prior to the analog-to-digital conversion from among the functions of the wireless unit 51 illustrated in FIG. 5, etc. The receiving circuit 123 includes an LNA (low noise amplifier) that amplifies the signal received by the antenna, a mixer that performs down-conversion of the amplified signal to the baseband using a signal having a predetermined frequency supplied from an oscillation device, a reception filter that extracts a signal of a desired bandwidth from the signal that has been subjected to the down-conversion, and the like. More specifically, the receiving circuit 123 performs quadrature demodulation for the reception signal, which has been subjected to the low noise amplification by a low noise amplifier, by carrier waves with 90 degree phase shift with respect to each other and thus generates an I-signal (In-phase signal) having the same phase as that of the reception signal and a Q-signal (Quad-phase signal) whose phase is delayed by 90 degrees with respect to the reception signal. The I-signal and the Q-signal are output from receiving circuit 123 after being subjected to the gain adjustment.

The control circuit 112 may control the operation of the transmission filter of the transmitting circuit 122 and the reception filter of the receiving circuit 123. Another controller that controls the transmitting circuit 122 and the receiving circuit 123 may be provided and the same or similar control may be realized by the control circuit 112 sending instructions to that controller.

The AD conversion circuits 117, 118 in the baseband unit 111 correspond to the section of the wireless unit 51 that performs the analog-to-digital conversion as illustrated in FIG. 5, etc. The AD conversion circuits 117, 118 perform analog-to-digital conversion for the input signal that is input from the receiving circuit 123. More specifically, the AD conversion circuit 117 converts the I-signal into a digital I-signal and the AD conversion circuit 118 converts the Q-signal into a digital Q-signal. It should be noted that quadrature demodulation may not be performed and only a single-channel signal may be received. In this case, only one AD conversion circuit has to be provided. In addition, when a plurality of antennas are provided, AD conversion circuits in the number corresponding to the number of the antennas may be provided. The reception processing circuit 114 corresponds to the section that performs the processing of the demodulator 56 as illustrated in FIG. 5, etc. Specifically, the reception processing circuit 114 performs demodulation processing for the signal that has been subjected to the analog-to-digital conversion, processing of removing the preamble and the PHY header, and the like processing, and delivers the frame that has been processed to the control circuit 112.

It should be noted that a switch may be arranged in the RF unit for switching the antennas 50(1) to 50(N) between the transmitting circuit 122 and the receiving circuit 123. By controlling the switch, the antennas 50(1) to 50(N) may be connected to the transmitting circuit 122 at the time of transmission and the antennas 50(1) to 50(N) may be connected to the receiving circuit 123 at the time of reception.

Although the DA conversion circuits 115, 116 and the AD conversion circuits 117, 118 are arranged on the side of the baseband unit 111 in FIG. 15, another configuration may be adopted where they are arranged on the side of the RF unit 121.

It should be noted that the wireless communicator may be formed by the transmitting circuit 122 and the receiving circuit 123. The wireless communicator may be formed by further adding DAs 115, 116 and the DAs 117, 118 to the transmitting circuit 122 and the receiving circuit 123. The wireless communicator may be formed by including, along with these components, the PHY processing portions (i.e., the modulator 55 and the demodulator 56) of the transmission processing circuit 113 and the reception processing circuit 114. Alternatively, the wireless communicator may be formed by the PHY reception processing portions (i.e., the modulator 55 and the demodulator 56) of the transmission processing circuit 113 and the reception processing circuit 114.

### Ninth Embodiment

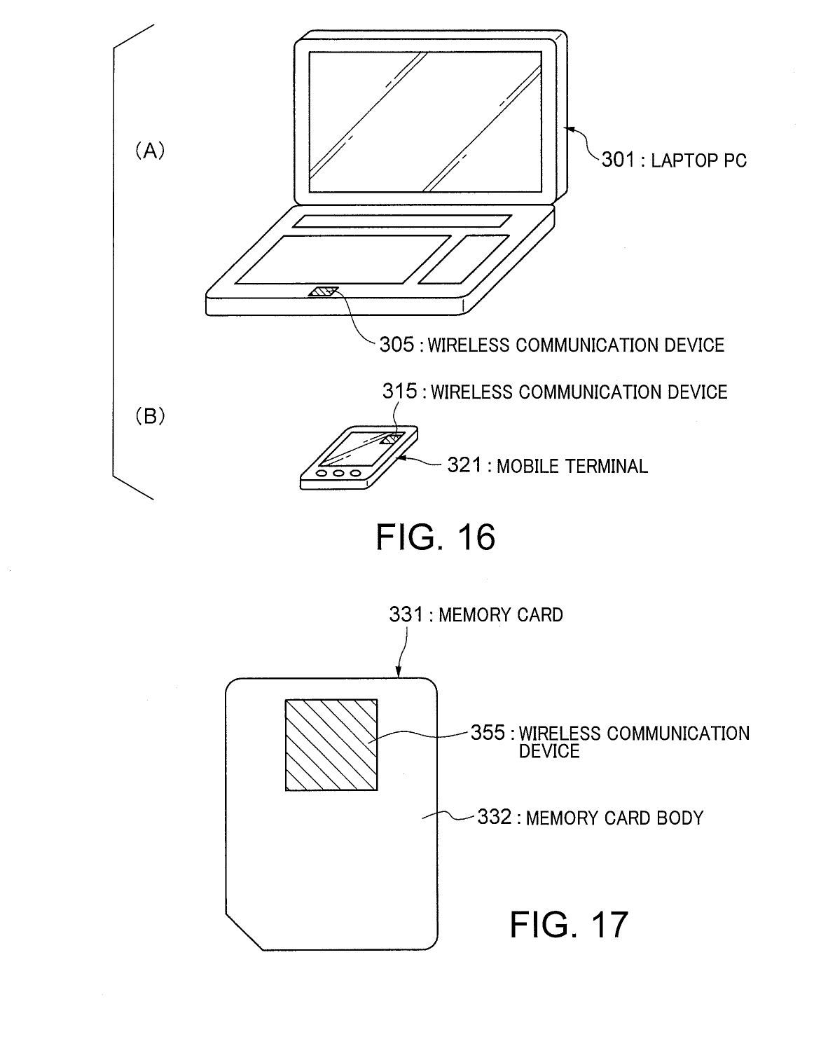

FIG. 16(A) and FIG. 16(B) are perspective views of a wireless communication terminal (wireless device) in accordance with a ninth embodiment. The wireless device of FIG. 16(A) is a laptop PC 301 and the wireless device of FIG. 16(B) is a mobile terminal 321. They correspond, respectively, to one form of the terminal (which may operate as either the base station or the slave station). The laptop PC 301 and the mobile terminal 321 incorporate the wireless communication devices 305, 315, respectively. The wireless communication devices that are previously described may be used as the wireless communication devices 305, 315. The wireless device incorporating the wireless communication device is not limited to the laptop PC or the mobile terminal. For example, the wireless communication device may be incorporated in a television, digital camera, wearable device, tablet, smartphone, etc.

In addition, the wireless communication device can be incorporated in a memory card. FIG. 17 illustrates an example where the wireless communication device is incorporated in the memory card. The memory card 331 includes a wireless communication device 355 and a memory card body 332. The memory card 331 uses the wireless communication device 335 for wireless communications with external devices. It should be noted that the illustration of the other elements in the memory card 331 (e.g., memory, etc.) is omitted in FIG. 17.

### Tenth Embodiment

A tenth embodiment includes a bus, a processor, and an external interface in addition to the configuration of the wireless communication device in accordance with any one of the first to ninth embodiments. The processor and the external interface are connected via the bus to the buffer. The firmware runs on the processor. In this manner, by providing a configuration where the firmware is included in the wireless communication device, it is made possible to readily modify the functionality of the wireless communication device by re-writing of the firmware.

### Eleventh Embodiment

An eleventh embodiment includes a clock generator in addition to the configuration of the wireless communication device in accordance with any one of the first to ninth embodiments. The clock generator is configured to generate a clock and output the clock on the output terminal and to the outside of the wireless communication device. In this manner, by outputting the clock generated within the wireless communication device to the outside thereof and causing the host side to operate based on the clock output to the outside, it is made possible to cause the host side and the wireless communication device side to operate in a synchronized manner.

### Twelfth Embodiment

A twelfth embodiment includes a power source, a power source controller, and a wireless power supply in addition to the configuration of the wireless communication device in accordance with any one of the first to ninth embodiments. The power source controller is connected to the power source and the wireless power supply, and is configured to perform control for selecting the power source from which power is supplied to the wireless communication device. In this manner, by providing a configuration where the power source is provided in the wireless communication device, it is made possible to achieve low power consumption operation accompanied by the power source control.

### Thirteenth Embodiment

A thirteenth embodiment includes a SIM card in addition to the configuration of the wireless communication device in accordance with the twelfth embodiment. The SIM card is connected, for example, to the MAC processor 53 in the wireless communication device or to the control circuit 112, etc. In this manner, by providing a configuration where the SIM card is provided in the wireless communication device, it is made possible to readily perform the authentication processing.

### Fourteenth Embodiment

A fourteenth embodiment includes a video compression/extension unit in addition to the configuration of the wireless communication device in accordance with the tenth embodiment. The video compression/extension unit is connected to a bus. In this manner, by configuring the video compression/extension unit included in the wireless communication device, it is made possible to readily perform transfer of the compressed video and the extension of the received compressed video.

### Fifteenth Embodiment

A fifteenth embodiment includes an LED unit in addition to the configuration of the wireless communication device in accordance with any one of the first to ninth embodiments. The LED unit is connected, for example, to the MAC processor 53 in the wireless communication device, the transmission processing circuit 113, the reception processing circuit 114, or the control circuit 112, etc. In this manner, by providing a configuration where the LED unit is provided in the wireless communication device, it is made possible to readily notify the operating state of the wireless communication device to the user.

### Sixteenth Embodiment

A sixteenth embodiment includes a vibrator unit in addition to the configuration of the wireless communication device in accordance with any one of the first to ninth embodiments. The vibrator unit is connected, for example, to the MAC processor 53 in the wireless communication device, the transmission processing circuit 113, the reception processing circuit 114, or the control circuit 112, etc. In this manner, by providing a configuration in which the vibrator unit is provided in the wireless communication device, it is made possible to readily notify the operating state of the wireless communication device to the user.

### Seventeenth Embodiment

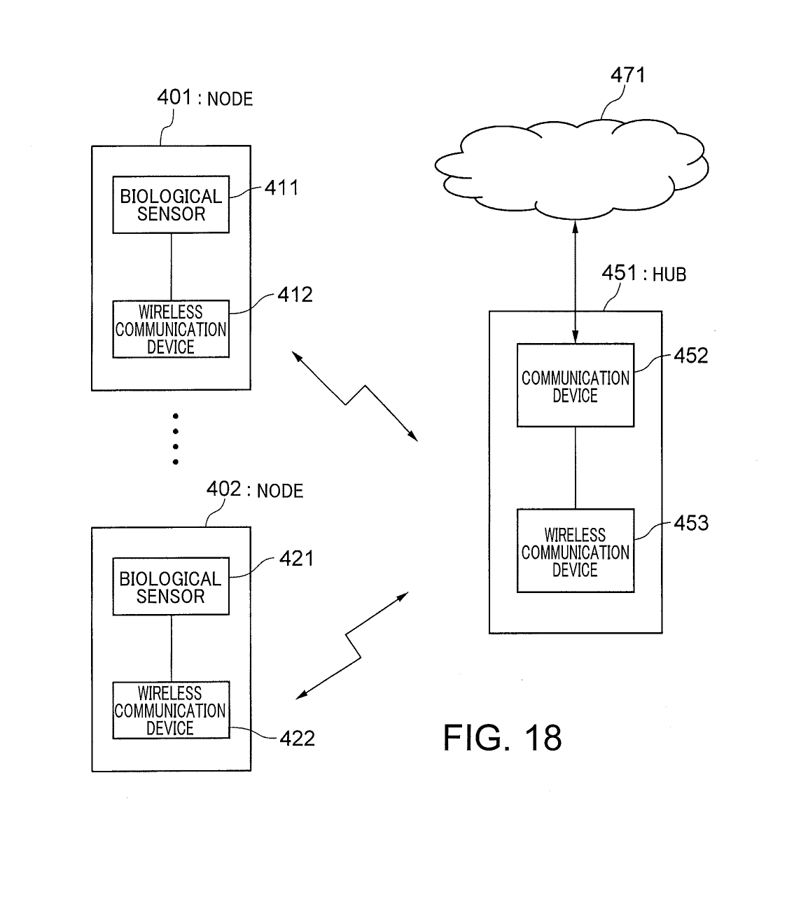

FIG. 18 illustrates an overall configuration of a wireless communication system in accordance with a seventeenth embodiment. This wireless communication system is an example of the body area network illustrated in the context of the second embodiment. The wireless communication system includes a plurality of nodes including nodes 401, 402 and a hub 451. Each node and the hub are attached to the human body, and each node performs wireless communication with the hub 451. Being attached to the human body may refer to any case where it is arranged at a position near the human body such as a form in which it is in direct contact with the human body; a form in which it is attached thereto with clothes existing in between; a form in which it is provided on a strap hanging from the neck; and a form in which it is accommodated in a pocket. The hub 451 is, by way of example, a terminal including a smartphone, mobile phone, tablet, laptop PC, etc.

The node 401 includes a biological sensor 411 and a wireless communication device 412. As the biological sensor 411, for example, sensors may be used that are adapted to sense body temperature, blood pressure, pulse, electrocardiogram, heartbeat, blood oxygen level, urinal sugar, blood sugar, etc. Meanwhile, sensors adapted to sense biological data other than these may be used. The wireless communication device 412 is any one of the wireless communication devices of the embodiments that are described in the foregoing. The wireless communication device 412 performs wireless communication with the wireless communication device 453 of the hub 451. The wireless communication device 412 performs wireless transmission of the biological data (sensing information) sensed by the biological sensor 411 to the wireless communication device 453 of the hub 451. The node 401 may be configured as a device in the form of a tag.

The node 402 includes a biological sensor 421 and a wireless communication device 422. The biological sensor 421 and the wireless communication device 422, the explanations of which are omitted, are configured in the same or similar manner as the biological sensor 411 and the wireless communication device 412 of the node 401, respectively.

The hub 451 includes a communication device 452 and a wireless communication device 453. The wireless communication device 453 performs wireless communications with the wireless communication device of each node. The wireless communication device 453 may be the wireless communication device described in the context of the previous embodiments or may be another wireless communication device other than those described in the foregoing as long as it is capable of communications with the wireless communication device of the node. The communication device 452 is wire or wireless-connected to the network 471. The network 471 may be the Internet or a network such as a wireless LAN, or may be a hybrid network constructed by a wired network and a wireless network. The communication device 452 transmits the data collected by the wireless communication device 453 from the individual nodes to devices on the network 471. The delivery of data from the wireless communication device 453 to the communication devices may be performed via a CPU, a memory, an auxiliary storage device, etc. The devices on the network 471 may, specifically, be a server device that stores data, a server device that performs data analysis, or any other server device. The hub 451 may also incorporate a biological sensor in the same or similar manner as the nodes 401 and 402. In this case, the hub 451 also transmits the data obtained by the biological sensor to the devices on the network 471 via the communication device 452. An interface may be provided in the hub 451 for insertion of a memory card such as an SD card and the like and the data obtained by the biological sensor or obtained from each node may be stored in the memory card. In addition, the hub 451 may incorporate a user inputter configured to input various instructions by the user and a display for image display of the data, etc.

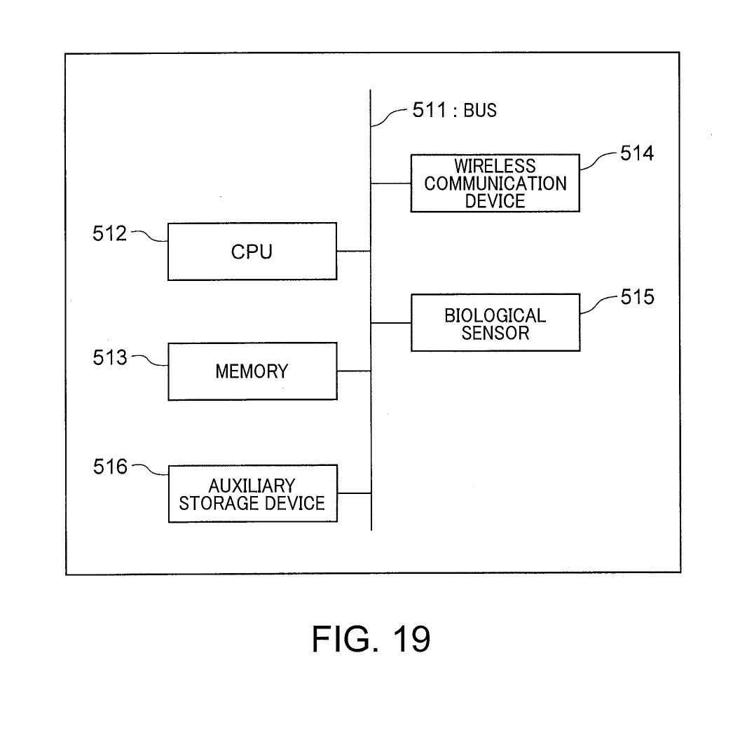

FIG. 19 is a block diagram illustrating a hardware configuration of the node 401 or node 402 illustrated in FIG. 18. The CPU 512, the memory 513, the auxiliary storage device 516, the wireless communication device 514, and the biological sensor 515 are connected to a bus 511. Here, the individual components 512 to 516 are connected to one single bus, but a plurality of buses may be provided by a chipset and the individual units 512 to 516 may be connected in a distributed manner to the plurality of buses. The wireless communication device 514 corresponds to the wireless communication devices 412, 422 of FIG. 18, and the biological sensor 515 corresponds to the biological sensor 411, 421 of FIG. 18. The CPU 512 controls the wireless communication device 514 and the biological sensor 515. The auxiliary storage device 516 is a device that permanently stores data such as an SSD, a hard disk, etc. The auxiliary storage device 516 stores a program to be executed by the CPU 512. In addition, the auxiliary storage device 516 may store data obtained by the biological sensor 515. The CPU 512 reads the program from the auxiliary storage device 516, develops it in the memory 513, and thus executes it. The memory 513 may be volatile memory such as DRAM, etc., or may be non-volatile memory such as MRAM, etc. The CPU 512 drives the biological sensor 515, stores data obtained by the biological sensor 515 in the memory 513 or the auxiliary storage device 516, and transmits the data to the hub via the wireless communication device 514. The CPU 512 may execute processing associated with communication protocols of layers higher than the MAC layer and processing associated with the application layer.

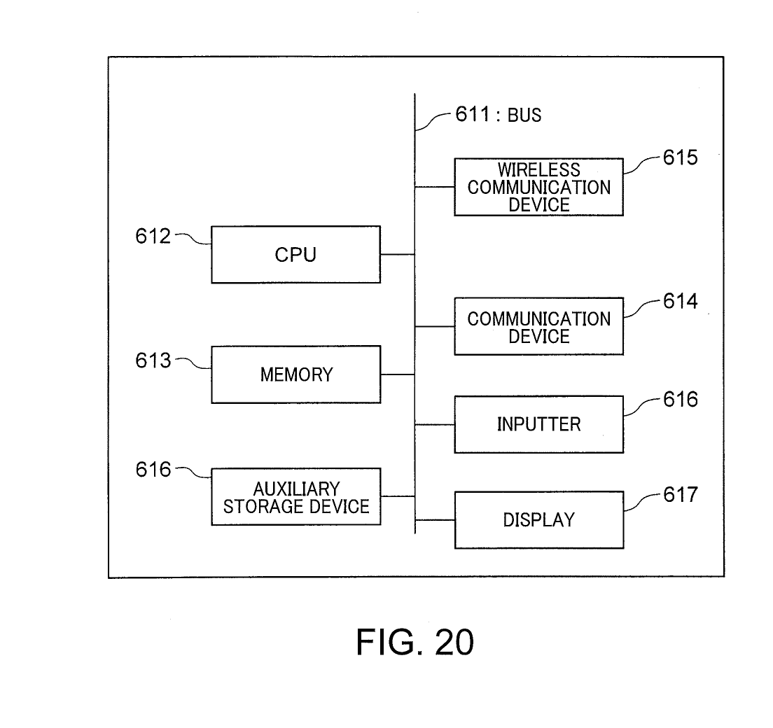

FIG. 20 is a block diagram that illustrates a hardware configuration of the hub 451 illustrated in FIG. 18. A CPU 612, a memory 613, an auxiliary storage device 616, a communication device 614, a wireless communication device 615, an inputter 616 and a display 617 are connected to a bus 611. Here, the individual units 612 to 617 are connected to one single bus, but a plurality of buses may be provided by a chipset and the individual units 612 to 617 may be connected in a distributed manner to the plurality of buses. A biological sensor or a memory card interface may further be connected to the bus 611. The inputter 616 is configured to receive various instruction inputs from the user and output signals corresponding to the input instructions to the CPU 612. The display 617 provides image display of the data, etc. as instructed by the CPU 612. The communication device 614 and the wireless communication device 615 correspond to the communication device 452 and the wireless communication device 453 provided in the hub of FIG. 18, respectively. The CPU 612 controls the wireless communication device 615 and the communication device 614. The auxiliary storage device 616 is a device that permanently stores data such as an SSD, a hard disk, etc. The auxiliary storage device 616 stores a program executed by the CPU 612 and may store data received from each node. The CPU 612 reads the program from the auxiliary storage device 616, develops it in the memory 613, and executes it. The memory 613 may be volatile memory such as DRAM, etc., or may be non-volatile memory such as MRAM, etc. The CPU 612 stores data received by the wireless communication device 615 from each node in the memory 613 or the auxiliary storage device 616, and transmits the data to the network 471 via the communication device 614. The CPU 612 may execute processing associated with communication protocols of layers higher than the MAC layer and processing associated with the application layer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

### REFERENCE SIGNS LIST

1, 60: wireless communication device (master station, hub)
2, 61 to 67: wireless communication device (slave station, node)
41: Communicator
50: Antenna
51: Wireless unit
52: Modulator-demodulator
53: MAC processor
54: Upper layer processor
55: Modulator
56: Demodulator
57: Transmitter
58: Receiver
59: Response scheme selector
70: Attachment position identifier
71: Buffer
72: Bus
73: Higher-order interface
74: Processor
75: Clock generator
80: Acceleration sensor
100 to 102: Biological sensor
110: Battery charge state detector
401, 402: Node
451: Hub
471: Network
511, 611: Bus
512, 612: CPU
513, 613: Memory
514, 615: Wireless communication device
515: Biological sensor
516, 616: Auxiliary storage device
614: Communication device

1-42. (canceled)

43: A communication processing device comprising:
a control circuit configured to:
receive a notification frame periodically transmitted;
select a first scheme when the notification frame has received successfully, or a second scheme when the notification frame has not received successfully; and
transmit a transmission frame including information requesting to send a response in accordance with the scheme selected.

44: The device according to claim 43, wherein the control circuit selects the second scheme when the control circuit has received the notification frame, and selects the first scheme when the control circuit has not received the notification frame.

45: The device according to claim 44, wherein
the control circuit switches from the first scheme to the second scheme, after transmission of the transmission frame including the information requesting to return the response in accordance with the first scheme, when a response to the transmission frame is received, and
the control circuit transmits a transmission frame including information requesting to send the response in accordance with the second scheme.

46: The device according to claim 43, wherein
the control circuit performs reception judgment of the notification frame at a reception timing in accordance with a transmission period of the notification frame, and
the control circuit incorporates the information into the transmission frame, which requests to send the response, until the next reception timing of the notification frame is reached, in accordance with the scheme selected at the reception judgment at the reception timing immediately before the next reception timing.

47: A communication processing device mounted in a wireless communication device, the communication processing device comprising:
a control circuit configured to select a first scheme corresponding to successful reception or a second scheme corresponding to unsuccessful reception in accordance with a location of the wireless communication device; and transmit a transmission frame including information requesting to send a response in accordance with the scheme selected.

48: The device according to claim 47, wherein
the wireless communication device is attached to a living body, and
the control circuit selects either of the schemes of the first scheme or the second scheme in accordance with a portion of the body to which the wireless communication device is attached.

49: The device according to claim 47, wherein the control circuit selects the second scheme when the wireless communication device is attached to a location or portion exhibiting a small amount of motion and selects the first scheme when the wireless communication device is attached to a location or portion exhibiting a large amount of motion.

50: The device according to claim 47, wherein
the wireless communication device is attached to a living body, and
the control circuit selects either the first scheme or the second scheme in accordance with a positional relationship between a portion of the living body to which a target communication device communicating with the wireless communication device is attached and a portion of the body to which the wireless communication device is attached.

51: The device according to claim 50, wherein the control circuit selects the second scheme when the wireless communication device is attached to the living body in a positional relationship that the living body does not act as a shielding object for the wireless communication device and selects the first scheme when the wireless communication device is attached in a positional relationship that the living body acts as the shielding object for the wireless communication device.

52: The device according to claim 47, further comprising an acceleration sensor, wherein the control circuit selects either the first scheme or the second scheme in accordance with a value of the acceleration sensor.

53: A communication processing device comprising:
a sensor;
a control circuit configured to:
select a first scheme corresponding to successful reception and a second scheme corresponding to unsuccessful reception in accordance with at least one of a type of the sensor, a usage of the sensor, and sensing information sensed by the sensor; and
transmit a transmission frame including information requesting to send the response in accordance with the scheme selected and the sensing information.

54: The device according to claim 53, wherein
the control circuit selects either the first scheme or the second scheme in accordance with a sensing time of the sensor.

55: The device according to claim 53, wherein either the first scheme or the second scheme is selected on the basis of: whether the sensing information is larger than a first threshold or lower than a second threshold; or whether a relative value of the sensing information to previous sensing information that had previously been obtained at least one round prior to the round at which the sensing information was obtained is larger than a third threshold or lower than a fourth threshold.

56: The device according to claim 53, wherein the control circuit performs determination of whether a degree of importance of the sensing information of the sensor corresponds to a first state where the degree of importance is normal or a second state where the degree of importance is higher than that of the first state, wherein the determination is performed on the basis of at least one of the type of the sensor, sensing information of the sensor, and the usage of the sensor; selects the second scheme when it has been determined that the degree of importance of the sensing information of the sensor corresponds to the first state; and selects the first scheme when the degree of importance of the sensing information of the sensor corresponds to the second state.
